(19) United States
(12) Patent Application Publication
(10) Pub. No.: US 2005/0021815 A1
(43) Pub. Date: Jan. 27, 2005

(54) Method and device for generating data, method and device for restoring data, and program

(76) Inventors: Naoya Haneda, Tokyo (JP); Kyoya Tsutsui, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/855,144

(22) Filed: May 27, 2004

(30) Foreign Application Priority Data
Jun. 9, 2003 (JP) P2003-163152

(51) Int. Cl. G06F 15/16

(52) U.S. Cl. 709/231

(57) ABSTRACT

A data playing device according to the present invention generates code frames of original data by performing restoration processing based on sample listening frames included in sample listening data and the additional frames corresponding to the sampling listening frames respectively, and plays or records the obtained code frames with high-quality sound. The present invention can be applied to a coding device, a playing device, a recording device or the like, whereby a user who has received distribution data listens to sample listening data included in the distribution data. If the user is satisfied with the contents, the user updates the license information by paying the price thereof using a predetermined method, and thus can flexibly deal with various contents data distribution services.

### BACKGROUND OF THE INVENTION

1. Field of the Invention

The present invention relates to a data generating method and a data generating device, a data restoration method and a data restoration device, and a program, and particularly relates to a data generating method and a data generating device, a data restoration method and a data restoration device, and a program, which are suitably used for distributing content data to users so as to allow users to use the data.

2. Description of the Related Art

Recently, the spread of communication network technology such as the Internet, improvement in information-compression technology, and further, increased integration or density of information recording media, has given rise to a vending style wherein digital contents made up of various types of multimedia data, such as audio, static images, moving images, and movies including audio and moving images for example, are distributed to a viewer via communication networks, in exchange for payment.

For example, stores which sell packaged media, such as CDs (Compact Disk), MDs (Mini-Disk), and the like, i.e., a recording medium on which a digital content has been already recorded beforehand, can sell not only packaged media but also a digital content by installing an information terminal, such as a so-called MMK (Multi Media KIOSK), and the like, in which a great number of digital contents including music data are stored.

A user inserts a recording medium, such as an MD which he/she has brought, into the MMK, selects the title of a digital content to purchase with reference to a menu screen, and pays the price of the contents requested. The method of payment for the price may be input in cash, an exchange of cybermoney, or electronic banking using a credit card or a prepaid card. The MMK records the selected digital content data onto the recording medium which the user has inserted, by predetermined processing.

A vender of digital contents can also distribute digital contents to users, through the Internet for example, as well as selling digital contents to users using MMKs, as mentioned above.

Thus, digital contents have come to be circulated even more effectively due to not only selling packaged media in which digital contents have been recorded beforehand, but also employing the technique of selling the digital content itself.

With such a vending style for digital contents, in order to circulate digital contents while protecting copyrights thereof, an arrangement has been made for example wherein all of a certain digital content, except for a part which can be listened to on trial, is enciphered and distributed to the user, thereby allowing only users who have purchased the encryption decode key to listen to all of the content including the enciphered part. This technique is disclosed in Japanese Unexamined Patent Application Publication No. 2001-103047 and Japanese Unexamined Patent Application Publication No. 2001-325460.

As a method for encryption, for example, a method has been known wherein the initial value of a random-number sequence serving as a key signal is assigned to a bit string of PCM (Pulse Code Modulation) digitized audio data and the exclusive-OR between the generated random-number sequence of zeroes and ones, and the PCM data to be distributed, is taken as a bit string. Thus, the enciphered digital content is recorded onto a recording medium using MMK, or the like, or is distributed via a network, thereby providing the user with the enciphered digital content. A user who has acquired the enciphered digital content data but has no key for decoding can try listening to only the part which is not enciphered and can be listened to on trial, and in this case, in the event that the user attempts to play the enciphered part without decoding, the user can only hear noise.

Moreover, technology for compressing and broadcasting audio data and the like, or distributing this data via a network, and also technology for recording compressed data onto various types of a recording medium, such as a magneto-optic disk, and the like have been improved.

There are various methods for high efficiency coding of audio data, for example, SBC (Sub Band Coding) for dividing unblocked audio signals on a time-axis into multiple frequency bands so as to realize coding, and the blocking frequency band division method (so-called conversion coding) for performing spectrum conversion from a signal on a time-axis to a signal on a frequency-axis, dividing the converted signal into multiple frequency bands, so as to realize coding for each band. Moreover, a technique is being developed wherein following performing band division by band division coding, spectrum conversion of the signal is carried out at the signal on a frequency-axis in each band, and encoding is performed for each band subjected to spectrum conversion.

An example of the filters used here is the QMF (Quadrature Mirror Filter), which is described in detail in “Digital coding of speech in subbands” (Bell Syst. Tech. J. Vol. 55, No. 8 1974) by R. E. Crochiere. Moreover, a filter division technique with equal bandwidth is described in “Polyphase Quadrature Fitters-Anew subband coding technique” (ICASSP 83, BOSTON) by Joseph H. Rothweiler. [0012]

Also, examples of the above-described spectrum conversion include DFT (Discrete Fourier Transform), DCT (Discrete Cosine Transform), MDCT (Modified Discrete Cosine Transform), and so forth, which divide input audio signals into blocks in predetermined units of time (frame) so as to perform spectrum conversion for each block. Of these, details of MDCT is described in “Subband/Transform Cording Using Filter Bank Designs Based on Time Domain Aliasing Cancellation” (ICASSP 1987) by J. P. Princen, A. B. Bradley and others (Univ. of Surrey Royal Melbourne Inst. of Tech.).

Also, in the event that DFT or DCT is employed as a method for carrying out spectrum conversion of wave signals, performing conversion at the time block made up of M samples yields M pieces of independent real data. In order to reduce the connection strain between the time blocks, adjacent blocks and every N/2 samples in each block, i.e., N samples in total of both the sides are overlapped, and accordingly, with DFT and DCT, M pieces of independent real data as to (M+N) samples are quantized and encoded on the average.

On the other hand, in the event that MDCT is employed as a spectrum conversion method, converting time blocks made up of M samples, yields M pieces of independent real data from adjacent blocks and every M/2 samples in each block, i.e., from 2M samples wherein M samples in total have both the sides are overlapped, and accordingly, with MDCT, M pieces of independent real data as to M samples are quantized and encoded on average.

With a decoding device, wave signals can be reconstituted by adding the wave element obtained by performing inverse transformation of each block based on the code obtained using MDCT effecting mutual interference.

Generally, lengthening the time block for conversion increases the frequency resolution of a spectrum, so that energy concentrates on a specific spectrum component. Therefore, performing conversion using MDCT wherein the conversion is performed with a long block length due to making adjacent blocks overlap by one half, and moreover wherein the number of the obtained spectrum signals does not increase as to the number of the basic time samples, enables encoding more efficiently than a case of using DFT or DCT for conversion. Moreover, the interblock gap distortion of wave signals can be reduced by overlapping adjacent blocks with a sufficiently great length.

As described above, quantizing the signal divided for each band using filtering or spectrum conversion can control the band in which quantizing noise is generated, and more high-efficiency coding can be performed acoustically using masking effects and so forth. Moreover, normalizing each band with the maximum absolute value of the signal component in the band enables further high-efficiency coding to be performed prior to quantization.

In the event of quantizing each frequency component subjected to frequency band division, the frequency-division width may be determined giving consideration to human acoustic-sense properties. That is to say, an audio signal may be divided into multiple bands (for example, 25 bands) such that the higher a particular band, generally called a critical band is, the wider the bandwidth thereof is.

Also, in the event that the band is divided so as to widen the critical band, predetermined bit distribution may be made to be performed for each band at the point of encoding data is for each band, or accommodative bit assignment (bit allocation) may be performed for each band.

For example, in the event that the coefficient data obtained by spectrum conversion using MDCT is encoded using bit allocation, the number of bits is assigned in an accommodative manner to the MDCT coefficient data for each band obtained by MDCT for each block so as to perform coding. As examples of the bit allocation technique, two techniques disclosed in “Adaptive Transform Coding of Speech Signals” (IEEE Transactions of Acoustics, Speech, and Signal Processing, Vol. ASSP-25, No. 4, August 1977), and “The critical band coder digital encoding of the perceptual requirements of the auditory system” (ICASSP 1980) are known. “Adaptive Transform Coding of Speech Signals” (IEEE Transactions of Acoustics, Speech, and Signal Processing, Vol. ASSP-25, No. 4, August 1977) by R. Zelinski, P. Noll et al., describes that the bit allocation is performed based on the magnitude of the signal for each band. According to this technique, the quantizing-noise spectrum becomes flat, and noise energy becomes minimum, however, in the event of taking into account the acoustic sense, this technique is not preferable in that this technique reduces the noise which can be actually heard by humans since masking effects are not employed in this technique.

Also, with “The critical band coder digital encoding of the perceptual requirements of the auditory system” (ICASSP 1980) by M. A. Kransner (Massachusetts Institute of Technology), the technique wherein a S/N (signal-to-noise) ratio required for each band is obtained using auditory masking so as to perform fixed bit allocation is described. However, with this technique, bit allocation is performed fixedly even in the event of measuring properties with sine wave input, so property values are not very good.

In order to solve these problems, high-efficiency-coding has been proposed wherein all bits which can be used for bit allocation are split into a fixed bit quota pattern which is determined for every small block beforehand, and a bit quota pattern dependent on the magnitude of the signal of each block, the split ratio being depends on the signal related to an input signal, and the smoother the spectrum of the signal is, the greater the split ratio of the fixed bit quota pattern is.

According to this method, in the event that energy concentrates on a specific spectrum like a sine wave input, a great number of bits can be allocated to the block including the spectrum, thereby improving the overall signal-to-noise property remarkably. Generally, human acoustic sense as to a signal with a steep spectrum component is very sensitive, and accordingly, this is effective in improving not only the property value with regard to measurement but also the tone quality of the sound which is actually heard by humans, thereby improving the signal-to-noise property.

Many methods for bit allocation have been proposed other than the above-described methods. Furthermore, owing to elaborated models regarding acoustic senses and improved capacities of coding devices, it is possible to perform high-efficiency coding regarding not only the property values in measurement but also regarding human acoustic sense. With these methods, it is common to obtain the bit quota reference value of the real number so as to realize as faithfully as possible the signal-to-noise property obtained by calculation, to obtain the integral value which approximates the reference value, and then to set the obtained integral value to the number of quota bits.

Also, Japanese Patent Application No. 5-152865 or WO 94/28633 previously applied by the present inventor, describes a method wherein the tone nature component especially important for acoustic senses, i.e., a component in which energy concentrates around the specific frequency, is separated, and how to encode this apart from other spectrum components. According to this method, audio signals and so forth can be effectively encoded with high compression ratio giving practically no impression of acoustic deterioration.

In a case of generating an actual code stream, first, quantization precision information and normalization coefficient information are encoded with the predetermined number of bits for each band where normalization and quantization are performed, and then the spectrum signals which have been normalized and quantized are encoded. Moreover, ISO/IEC 11172-3; (1993 (E) a933) describes a high-efficiency-coding method wherein the number of bits representing quantization precision information is set to differ depending on the band, and it is stipulated therein that the higher the band is, the smaller the number of bits representing quantization precision information is.

With a decoding device, a method for determining quantization precision information from normalization coefficient information for example, is also known instead of directly encoding quantization precision information. The relation between normalization coefficient information and quantization precision information is determined at the point of setting specifications in this method, and accordingly, this method does not permit introducing control using quantization precision based on a still more advanced acoustic-sense model. Moreover, in the event that the compression ratios to be realized are over a range with a certain width, there is the need to define the relation between normalization coefficient information and quantization precision information for each compression ratio.

As a method for more effectively encoding the quantized spectrum signal, for example, a method using variable-length code is known, as described in “A Method for Construction of Minimum Redundancy Codes” (Proc. I.R.E., 40, p.1098, 1952) by D. A. Huffman.

It is also possible to encipher and distribute the content data encoded using the above-described method in the same way as in a case of a PCM signal, and in the event of employing this contents protection method, a user who has not received the key signal cannot reproduce the original signal. Also, there is a method for performing encoding for compression following converting a PCM signal to a random signal rather than enciphering a coding bit train, and in the event of employing this contents protection method, a user who has not received the key signal can only reproduce noise.

Also, sales of contents data can be promoted by distributing the sample listening data of contents data. Examples of the sample listening data include data which can be played in low quality sound rather than the original quality, and data of which a part of the original data (for example, only the refrain) can be played, and the like. In the event that a user has listened to the sample listening data, and is pleased with the sample listening data, the user may purchase the key for decoding the code so as to reproduce the original content data, or may newly purchase a recording medium on which the original content data is recorded.

However, with the above-described contents protection method, the entire data cannot be played, or if played is only noise, and accordingly, even if the data scrambled in this method is distributed to a user as the sample listening data, the user cannot grasp the overall image of the entire data. Moreover, a recording medium on which audio is recorded relatively low-quality for example, cannot be distributed as the sample listening data.

Furthermore, with the conventional methods, in the event of enciphering the signal subjected to high-efficiency coding, it has been very difficult for a playing device commonly used to prevent deterioration of the compression efficiency thereof while yielding a meaningful code stream. That is, in the event that scrambling is applied to the code stream generated by being subjected to high-efficiency coding, even if playing is attempted without descrambling the code stream, only noise can be heard, and moreover, in the event that the code stream generated by scrambling does not conform to the specification of the original high-efficiency code serving, playing processing may be completely impossible.

On the other hand, in the event that a PCM signal is subjected to high-efficiency coding following scrambling being applied thereto, for example, reducing the amount of information using acoustic sense properties results in irreversible coding. Accordingly, even if such a high-efficiency coding is decoded, the signal in which the scramble was applied to the PCM signal cannot be correctly played. In other words, it will be very difficult to descramble such a signal correctly. Therefore, with distribution of the sample listening data, methods for descrambling scrambled signals have been chosen at the expense of compression efficiency.

In order to solve the above-described problems, Japanese Unexamined Patent Application Publication No. 10-135944 previously applied by the present assignee, discloses an audio coding method wherein, of music data which has been converted to spectrum signals so as to be encoded, the data of which the code corresponding to the high bandwidth has been enciphered is distributed as the sample listening data, which allows users who do not have the key to decode and play the signals of the narrow bandwidth which have not been enciphered. In this method, the bit quota information on the side of the high region is substituted with dummy data as well as the code on the side of the high region being enciphered, and the true bit quota information by the side of the high region is recorded at the position where the decoder does not scan (ignores) information at the time of playing processing.

With this method, a user plays the distributed sample listening data, and in the event that the user likes the content as a result of the sample listening, the user purchases the key for decoding the sample listening data into the original data, whereby the desired music or the like can be correctly played in all bands so as to enjoy high-quality sound.

Now, in recent years, in addition to metered purchasing distribution services for purchasing content data for each title as described above, so-called fixed subscription services are being offered, wherein a great number of musical compositions can be freely listened to in the same sound quality as with the metered purchasing distribution service within a predetermined period of time, such as one month.

Examples of a method for restricting the limit of time. for usage of content data, which is used in this subscription service, includes the method disclosed in Japanese Unexamined Patent Application Publication No. 10-269144, and the like. According to this method, content data exceeding a predetermined limit of time that has been set beforehand cannot be used hereafter, thereby preventing unauthorized usage of contents.

Also, examples of a method for realizing a device which restricts the limit of time for usage of contents data includes the method disclosed in Japanese Unexamined Patent Application Publication No. 2002-116960, and the like. According to this method, a user can copy content data which is used in a home personal computer or a home server to portable apparatus, or use the copied content data in the portable apparatus away from home, as long as within the limit of time for usage set beforehand.

However, with the above-described methods, content data exceeding a predetermined limit of time for usage is rendered completely unusable thereafter, and accordingly, the unauthorized usage of content data can be prevented, but this has been problematic in that various types of distribution services cannot be handled flexibly.

For example, according to the conventional method for restricting the limit of time for usage of contents data, the method cannot correspond to, for example, contents data distribution services wherein the sample listening content data which can be listened to in low quality sound only is distributed, only users who have paid a predetermined monthly fee can play the content data in high-quality sound for one month only, and when the period of one month elapses, the content data can be played in low quality sound only again.

### SUMMARY OF THE INVENTION

Accordingly, the present invention has been made in light of such a situation, and it is an object of the present invention to handle various types of contents data distribution services flexibly.

According to a first aspect of the present invention, a data generating method comprises: a first generating step for substituting first data included in a first data stream with second data so as to generate a second data stream; a second generating step for generating a third data stream including the first data for restoring the first data stream from the second data stream generated by the processing of the first generating step; and a third generating step for generating control data for stipulating at least one of a condition for restoring the first data stream from the second data stream using the third data stream; and a condition for usage of the first data stream restored from the second data stream.

The control data may stipulates at least one of the limit of time, the period of time, and the number of times, as a condition for permitting restoring of the first data stream from the second data stream. The control data may also stipulate conditions for recording the data stream onto other recording media.

With the processing of the first generating step, the first data may be substituted with the second data such that output quality obtained by restoring the second data stream is inferior to output quality obtained by restoring the first data stream.

The data generating method may further include a coding step for encoding data input, wherein, with the processing of the first generating step, in a case of using coded data encoded by the coding step as the first data stream, the second data stream is generated by substituting the first data stream with the second data stream. The first data may include at least one of normalization coefficient information and quantization precision information of coding by the processing of the coding step.

The data generating method may further comprise: a frequency component conversion step for converting input data to a frequency component; and a coding step for encoding the data converted to a frequency component by the processing of the frequency component conversion step; wherein, with the processing of the first generating step, in a case of using coded data encoded by the coding step as the first data stream, the first data is substituted with the second data so as to generate the second data stream; and wherein the first data includes spectrum coefficient information of the frequency component converted by the processing of the frequency component conversion step.

The first data may include data subjected to variable length coding. Also, conditions stipulated by the control data may be updatable conditions.

According to a second aspect of the present invention, a data generating device comprises: first generating means for generating a second data stream by substituting first data included in a first data stream with second data; second generating means for generating a third data stream including the first data for restoring the first data stream from the second data stream generated by the first generating means; and third generating means for stipulating at least one of a condition for restoring the first data stream from the second data stream using the third data stream, and a condition for usage of the first data stream restored from the second data stream.

According to a third aspect of the present invention, a computer-readable program comprises: code for a first generating step for generating a second data stream by substituting first data included in a first data stream with second data; code for a second generating step for generating a third data stream including the first data for restoring the first stream from the second data stream generated by the processing of the first generating step; and code for a third generating step for stipulating at least one of a condition for restoring the first data stream from the second data stream using the third data stream, and a condition for usage of the first data stream restored from the second data stream.

According to a fourth aspect of the present invention, a data restoring method for restoring a first data stream from a predetermined data stream comprises: a restoring step for restoring the first data stream from a second data stream generated by substituting first data included in the first data stream with second data using a third data stream including the first data; and a determining step for determining whether or not the first data stream can be restored by the restoring step based on a condition for restoring the first data stream from the second data stream, which is stipulated by control data; wherein the restoration of the first data stream by the processing of the restoring step is performed in the event that determination is made that the first data stream can be restored by the processing of the determining step.

The control data may further stipulate a condition for usage of the first data stream restored from the second data stream.

The data restoring method may further comprise a recording control step for recording the first data stream restored by the processing of the restoring step onto a predetermined recording medium, wherein recording of the first data stream is performed using the processing of the recording control step in the event that recording of the first data stream is permitted under a condition for usage of the first data stream, which is stipulated by the control data.

According to a fifth aspect of the present invention, a data restoring device for restoring a first data stream from a predetermined data stream comprises: restoring means for restoring the first data stream from a second data stream generated by substituting first data included in the first data stream with second data using a third data stream including the first data; and determining means for determining whether or not the first data stream can be restored by the restoring means based on a condition for restoring the first data stream from the second data stream, which is stipulated by control data; wherein the restoring means perform the restoration of the first data stream in the event that the determining means determine that restoration of the first data stream can be performed.

According to a sixth aspect of the present invention, a program for causing a computer to execute processing for restoring a first data stream from a predetermined data stream comprises: code for a restoring step for restoring the first data stream from a second data stream generated by substituting first data included in the first data stream with second data using a third data stream including the first data; and code for a determining step for determining whether or not the first data stream can be restored by the restoring step based on a condition for restoring the first data stream from the second data stream, which is stipulated by control data; wherein the restoration of the first data stream by the processing of the restoring step is performed in the event that determination is made that the first data stream can be restored by the processing of the determining step.

With the data generating method and the data generating device, and the first program according to the present invention, a second data stream is generated by substituting first data included in a first data stream with second data, a third data stream including the first data for restoring the first data stream from the second data stream is generated, and control data for stipulating at least either a condition for restoring the first data stream from the second data stream using the third data stream, or a condition for usage of the first data stream restored from the second data stream is generated.

With the data restoring method and the data restoring device, and the second program according to the present invention, the first data stream is restored from a second data stream generated by substituting first data included in the first data stream with second data using a third data stream including the first data, determination is made whether or not the first data stream can be restored by the restoring step based on a condition for restoring the first data stream from the second data stream, which is stipulated by control data, and then in the event that determination is made that the first data stream can be restored, the restoration of the first data stream is performed.

Thus, data streams can be converted, and license conditions are stipulated by control data, thereby generating data corresponding to various types of distribution services flexibly.

Also, data streams can be restored, and license conditions stipulated by control data are updated, thereby optimizing contents use according to how the user plans to use the contents.

### BRIEF DESCRIPTION OF THE DRAWINGS

FIG. 1 is a block diagram illustrating a configuration example of a data distribution system to which the present invention is applied;

FIG. 2 is a block diagram illustrating a configuration example of the coding device in FIG. 1;

FIG. 3 is a block diagram illustrating a configuration example of the converting unit in FIG. 3;

FIG. 4 is an explanatory diagram describing spectrum signals and band quantization units;

FIG. 5 is a block diagram illustrating a configuration example of the signal component coding unit in FIG. 2;

FIG. 6 is an explanatory diagram describing tone components and non-tone components;

FIG. 7 is a block diagram illustrating a configuration example of the tone component coding unit in FIG. 5;

FIG. 8 is a block diagram illustrating a configuration example of the non-tone component coding unit in FIG. 5;

FIG. 9 is a diagram illustrating a frame format example of original data;

FIG. 10 is a block diagram illustrating a configuration example of the data separation unit in FIG. 2;

FIG. 11 is a diagram illustrating a format example of a sample listening frame;

FIG. 12 is a diagram illustrating an example of a spectrum signal corresponding to the sample listening data in FIG. 11;

FIG. 13 is a diagram illustrating a format example of an additional frame;

FIG. 14 is a diagram illustrating a format example of distribution data;

FIG. 15 is an explanatory diagram of a specific example of high-quality sound data which is restored based on distribution data;

FIG. 16 is a flowchart describing distribution data generation processing;

FIG. 17 is a block diagram illustrating a configuration example of the data playing device in FIG. 1;

FIG. 18 is a block diagram illustrating a configuration example of the signal component decoding unit in FIG. 17;

FIG. 19 is a block diagram illustrating a configuration example of the tone component decoding unit in FIG. 18;

FIG. 20 is a block diagram illustrating a configuration example of the non-tone component decoding unit in FIG. 18;

FIG. 21 is a block diagram illustrating a configuration example of the inverse conversion unit in FIG. 17;

FIG. 22 is a flowchart describing data playing processing;

FIG. 23 is a flowchart describing code stream restoration processing;

FIG. 24 is a block diagram illustrating a configuration example of the data recorder;

FIG. 25 is a flowchart describing recording data processing; and

FIG. 26 is a block diagram illustrating a configuration example of a personal computer.

### DESCRIPTION OF THE PREFERRED EMBODIMENTS

The following is a description of embodiments of the present invention, immediately following is a description of how the configuration requirements given in the Summary of the Invention and the specific examples described below correspond. It should be understood that this description is for confirming that the specific examples that support the present invention described in the Summary of the Invention are also described here. Accordingly, even in the event that a specific example described here does not clearly correspond to a configuration requirement, this does not mean that this specific example does not correspond to the configuration requirements. Conversely, even if the specific example is described here so as to correspond to the configuration requirement, this does not mean that the specific example does not correspond to other configuration requirements other than that configuration requirement. To reiterate, it should be clearly understood that the description immediately following is only for illustrating this correlation, and is not to be interpreted restrictively by any means.

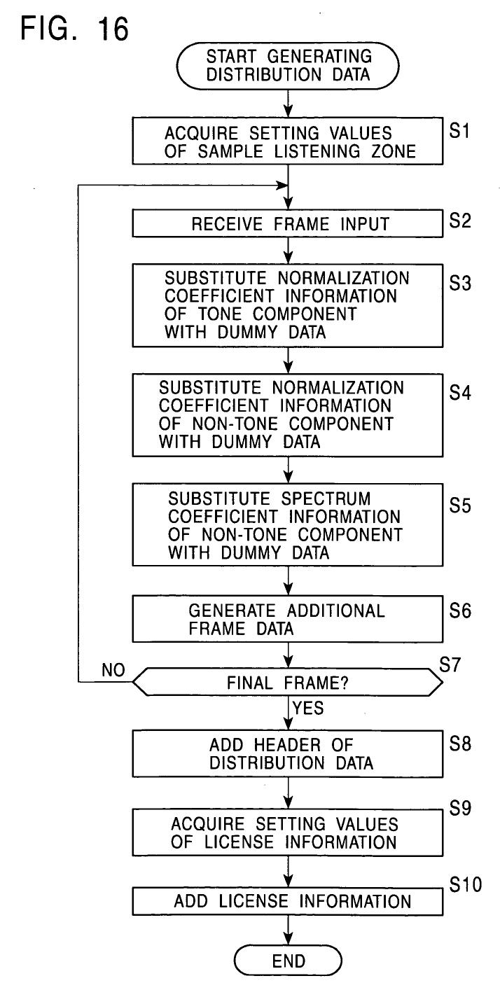

The data generating method according to the first aspect of the invention comprises a first generating step (for example, Step S2 through S6 in FIG. 16) for substituting first data (for example, a part of spectrum coefficient) included in a first data stream (for example, original data) with second data (for example, dummy spectrum coefficient) so as to generate a second data stream (for example, sample listening data); a second generating step (for example, Step S6 in FIG. 16) for generating a third data stream (for example, additional data) including the first data for restoring the first data stream from the second data stream generated by the processing of the first generating step; and a third generating step (for example, Step S10 in FIG. 16) for generating control data (for example, license information) for stipulating at least one of a condition for restoring the first data stream from the second data stream using the third data stream, and a condition for usage of the first data stream restored from the second data stream.

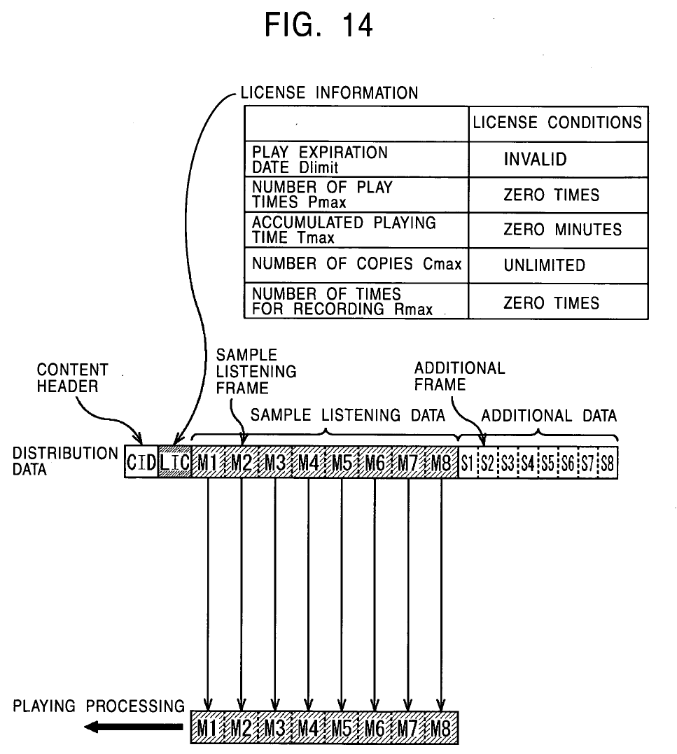

The control data stipulates at least one of the limit of time, the period of time, and the number of times (for example, the limit of time for playing and the number of play times in FIG. 14), as a condition for permitting restoring of the first data stream from the second data stream.

The control data stipulates a condition (for example, the number of copies and the number of times for recording in FIG. 14) for recording the data stream onto other recording medium.

The first generating step substitutes the first data with the second data such that output quality obtained by restoring the second data stream inferior to output quality obtained by restoring the first data stream.

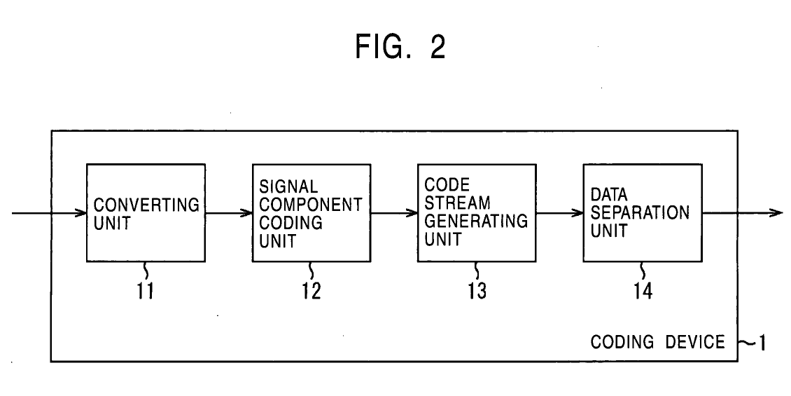

The data generating method further comprises a coding step (for example, processing executed by the code stream generating unit 13 in FIG. 2) for encoding data input, and generating the second data stream by substituting the first data stream with the second data stream when using coded data encoded by the coding step as the first data stream in the processing of the first generating step.

The first data comprises at least either normalization coefficient information or quantization precision information of coding by the processing of the coding step.

The data generating method further comprises a frequency component conversion step (for example, processing executed by the converting unit 11 in FIG. 2) for converting input data to a frequency component; and a coding step (for example, processing executed by the code stream generating unit 13 in FIG. 2) for encoding the data converted to a frequency component by the processing of the frequency component conversion step, and generating the second data stream by substituting the first data with the second data when coded data encoded by the coding step is taken as the first data stream in the processing of the first generating step, with the first data including spectrum coefficient information of the frequency component converted by the processing of the frequency component conversion step.

The first data comprises data subjected to variable length coding (for example, spectrum coefficient information).

The conditions stipulated by the control data are updatable conditions.

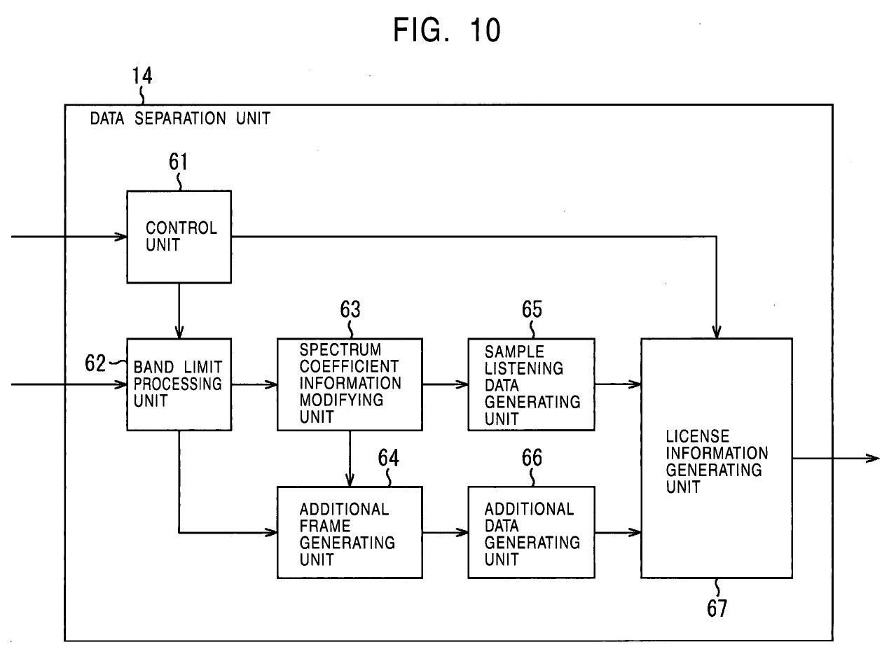

The data generating device according to the second aspect of the invention comprises a first generating unit (for example, the sample listening data generating unit 65 in FIG. 10) for generating a second data stream by substituting first data included in a first data stream with second data; a second generating unit (for example, the additional data generating unit 66 in FIG. 10) for generating a third data stream including the first data for restoring the first data stream from the second data stream generated by the first generating unit; and a third generating unit (for example, the license information generating unit 67 in FIG. 10) for stipulating at least one of a condition for restoring the first data stream from the second data stream using the third data stream, and a condition for usage of the first data stream restored from the second data stream.

The program according to the third aspect of the invention causes a computer to execute processing including a first generating step (for example, Steps S2 through S6 in FIG. 16) for generating a second data stream by substituting first data included in a first data stream with second data; a second generating step (for example, Step S6 in FIG. 16) for generating a third data stream including the first data for restoring the first stream from the second data stream generated by the processing of the first generating step; and a third generating step (for example, Step S10 in FIG. 16) for stipulating at least one of condition for restoring the first data stream from the second data stream using the third data stream, and a condition for usage of the first data stream restored from the second data stream.

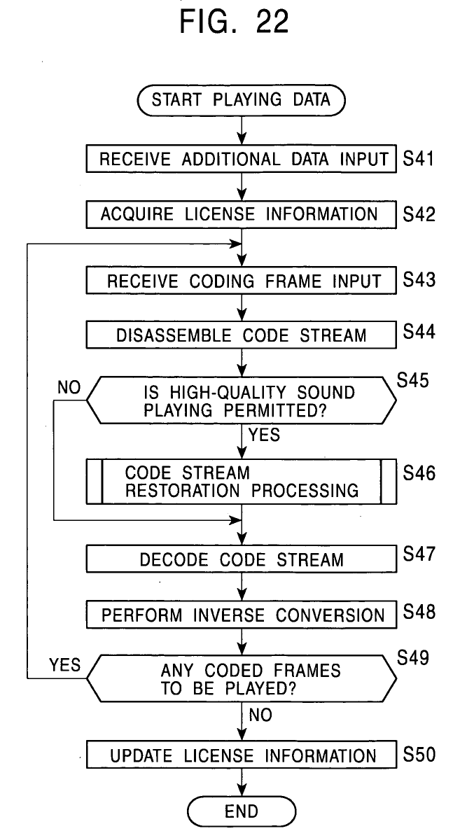

The data restoring method according to the fourth aspect of the invention comprises a restoring step (for example, Step S46 in FIG. 22) for restoring the first data stream (for example, original data) from a second data stream (for example, sample listening data) generated by substituting first data (for example, a part of spectrum coefficient) included in the first data stream with second data (for example, dummy spectrum coefficient) using a third data stream including the first data; and a determining step (for example, Step S45 in FIG. 22) for determining whether or not the first data stream can be restored by the restoring step based on a condition for restoring the first data stream from the second data stream, which is stipulated by control data (for example, license information), and performing restoration of the first data stream by the processing of the restoring step in the event that determination is made that the first data stream can be restored by the processing of the determining step.

The control data further stipulates a condition (for example, the number of copies and the number of times for recording in FIG. 14) for usage of the first data stream restored from the second data stream.

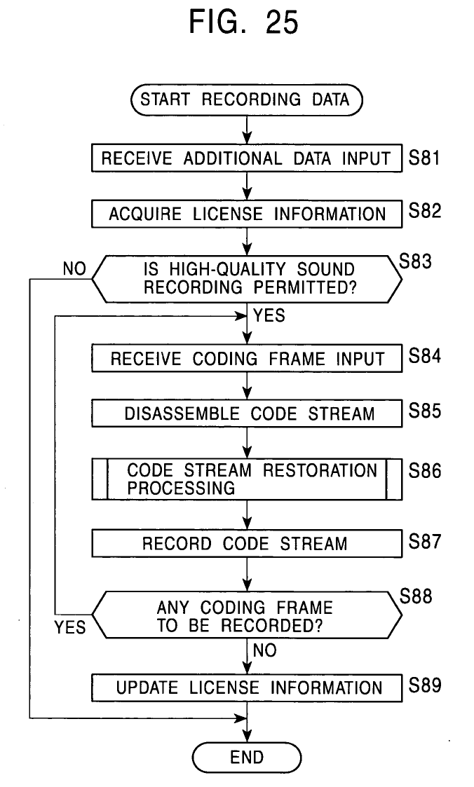

The data restoring method further comprises a recording control step (for example, Step S87 in FIG. 25) for recording the first data stream restored by the processing of the restoring step onto a predetermined recording medium, and performing recording of the first data stream using the processing of the recording control step in the event that recording of the first data stream is permitted under a condition for usage of the first data stream, which is stipulated by the control data.

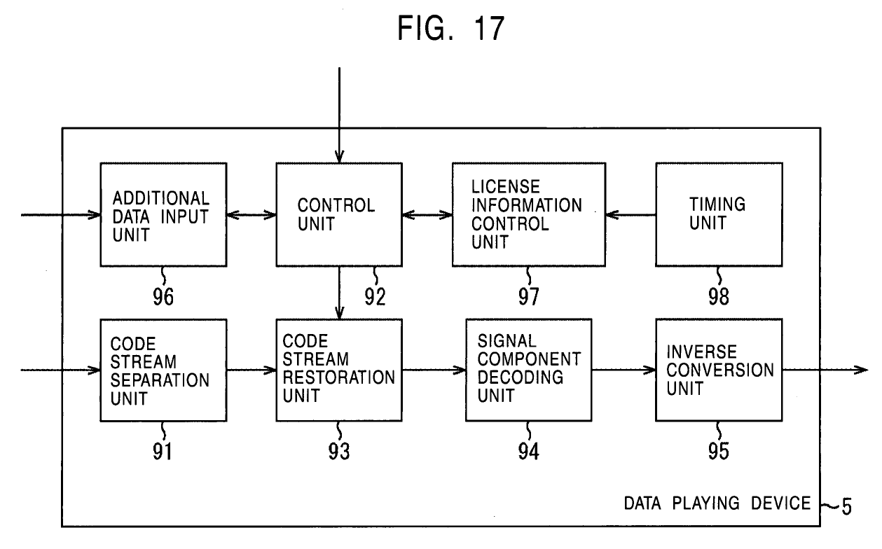

The data restoring device according to the fifth aspect of the invention comprises a restoring unit (for example, the code stream restoration unit 93 in FIG. 17) for restoring the first data stream from a second data stream generated by substituting first data included in the first data stream with second data using a third data stream including the first data; and a determining unit (for example, the license information control unit 97 in FIG. 17) for determining whether or not the first data stream can be restored by the restoring unit based on a condition for restoring the first data stream from the second data stream, which is stipulated by control data, with the restoring unit performing the restoration of the first data stream in the event that the determining unit determines that restoration of the first data stream can be performed.

The program according to the sixth aspect of the invention causes a computer to execute processing including a restoring step (for example, Step S46 in FIG. 22) for restoring the first data stream from a second data stream generated by substituting first data included in the first data stream with second data using a third data stream including the first data; and a determining step (for example, Step S45 in FIG. 22) for determining whether or not the first data stream can be restored by the restoring step based on a condition for restoring the first data stream from the second data stream, which is stipulated by control data, and performing restoration of the first data stream by the processing of the restoring step in the event that determination is made that the first data stream can be restored by the processing of the determining step.

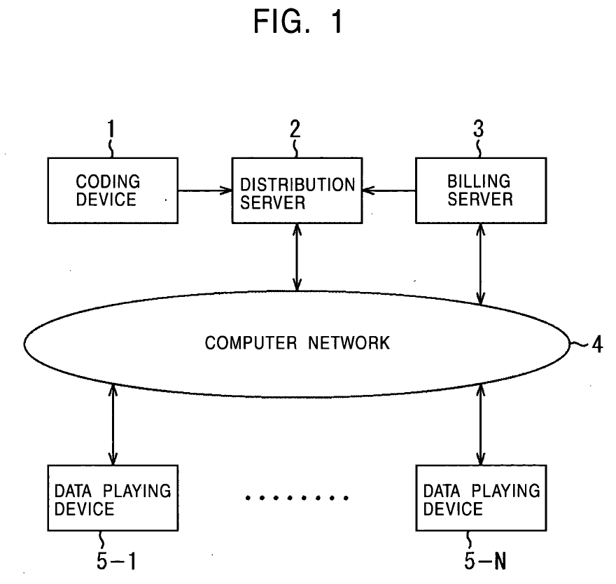

Description will be made below regarding embodiments of the present invention with reference to the drawings. FIG. 1 is a block diagram illustrating a configuration example of a data distribution system to which the present invention is applied.

A coding device 1 generates low-quality sample listening data from original data music contents, and also generates additional data including data required for restoring the original data from the sample listening data, for example. Also, the coding device 1 enciphers the generated sample listening data and additional data as necessary, and then encapsulates these (as a package of data) so as to supply the obtained distribution data to a distribution server 2.

The distribution server 2 distributes the distribution data supplied from the coding device 1 to a predetermined device of data playing devices 5-1 through 5-N via a cable or wireless computer network 4 with charge or free of charge. In the example in FIG. 1, N data playing devices 5 are connected to the computer network 4.

In the event that the user of the data playing device 5 operates the data playing device 5 so as to play the sample listening data included in the distribution data, is satisfied with the content, and wants to purchase the original data thereof for a per-download charge (in the event of paying charges for each content data), the user acquires (downloads) license information for restoring the original data from the distribution data from the distribution server 2, decodes the code as necessary, and then restores the original data from the sample listening data. The user records the original data thus restored onto a predetermined recording medium, or the like, so as to use the data.

Alternately, in the event that the user wants to join a fixed-charge subscription-type service such as by the month, for example, and then use the original data, the user acquires license information for playing the distribution data in high quality from the distribution server 2, decodes the code as necessary, and then restores the original data from the sample listening data. The user plays the original data thus restored in high quality without any change.

Note that this license information is paid information, for example, which can be updated by paying the charge. In the event that the user obtains the license information, and then restores the original data from the distribution data, the user needs to access a billing server 3 so as to perform payment procedures prior to acquiring the license information. Accordingly, the distribution server 2, in response to the notification from the billing server 3 that the payment procedures of the user has been completed, distributes the license information required by the user of the data playing device 5. Thus, the user of the data playing device 5 can use the original data within a range permitted by the license information.

Moreover, updating the license information alone allows the user to use the original data again, though use thereof has been prohibited temporarily, and accordingly, the user does not need to download the entire original data from the distribution server 2 again. In other words, the user can again use the original data which has become unusable, by downloading the license information (new license information) alone.

FIG. 2 is a block diagram illustrating a configuration example of the coding device 1 in FIG. 1 for generating sample listening data and additional data in response to an acoustic wave signal input. A case will be described here wherein high efficiency coding is performed using SBC (Sub Band Coding), ATC (Adaptive Transform Coding), and appropriate bit allocation, in response to a digital signal such as an audio PCM signal, or the like. ATC is a coding method for adjusting bit allocation based on DCT (Discrete Cosine. Transform) or the like, and more specifically, input signals are converted to spectrum signals for each time block, respective spectrum signals are normalized in batch for each predetermined band, i.e., each signal component is divided with a normalization coefficient approximating the maximum signal component, and then is quantized with the quantization precision determined at a suitable timing according to the property of the signal, thereby obtaining coding thereof.

A converting unit 11, in response to an acoustic wave signal input, converts the signal to a signal frequency component, and then outputs the component to a signal component coding unit 12. The signal component coding unit 12 encodes the input signal frequency component, and then outputs the code to a code stream generating unit 13. The code stream generating unit 13 generates a code stream from the signal frequency component encoded by the signal component coding unit 12, and then outputs the generated code stream to a data separation unit 14.

The data separation unit 14 performs predetermined processing such as rewriting the normalization coefficient information on the code stream input from the code stream generation unit 13, inserting license information thereinto, and the like, whereby the original data capable of playing in high quality sound is converted into sample listening data capable of playing in low quality sound, and additional data (restoration data) corresponding to the sample listening data, which is used by the user who wants to also play the original data or record the original data onto a predetermined recording medium, is generated. Also, the data separation unit 14 encapsulates the generated sample listening data and additional data, and then outputs these to the distribution server 2 as distribution data.

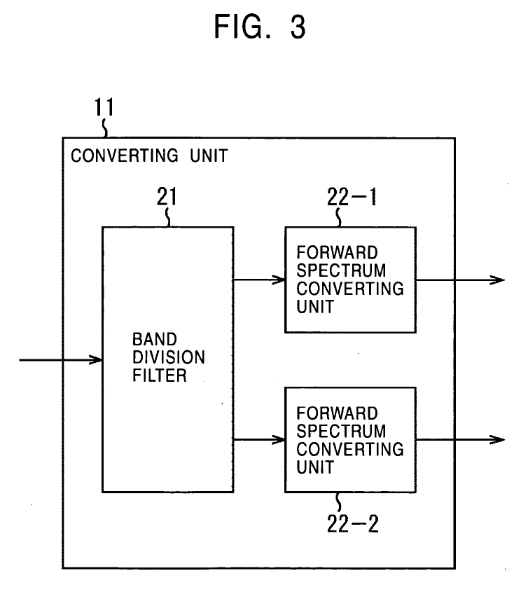

FIG. 3 is a block diagram illustrating a more detailed configuration example of the converting unit 11. The acoustic wave signal input to the converting unit 11 is divided into two bands by a band division filter 21, and the divided signals are output to forward spectrum converting units 22-1 and 22-2 respectively. The forward spectrum converting units 22-1 and 22-2 convert the input signal into a spectrum signal component using MDCT for example, and then output the component to the signal component coding unit 12. The signals input to the forward spectrum converting units 22-1 and 22-2 are one half bandwidth of the signal input to the band division filter 21, and the signals input are also thinned to one half respectively.

Note that while description of the converting unit 11 in FIG. 3 has been made assuming that the two signals divided by the band division filter 21 are converted to spectrum signal components using MDCT (Modified Discrete Cosine Transform), any method may be employed as a method for converting a signal input to a spectrum signal component. For example, a signal input may be converted to a spectrum signal component using MDCT without performing band division of the signal input, or the signal input may be converted to a spectrum signal using DCT (Discrete Cosine Transform) or DFT (Discrete Fourier Transform). Though it is possible to divide the signal input to band components using a so-called band division filter, spectrum conversion is preferably performed using MDCT, DCT, or DFT, which are capable of computing a great number of frequency components with a relatively small computing amount.

Also, in FIG. 3, while description has been made regarding an arrangement wherein the acoustic wave signal input is divided into two bands at the band division filter 21, the number of band divisions is by no means restricted to two. The information representing the number of band divisions at the band division filter 21 is output to the code stream generating unit 13 via the signal component coding unit 12.

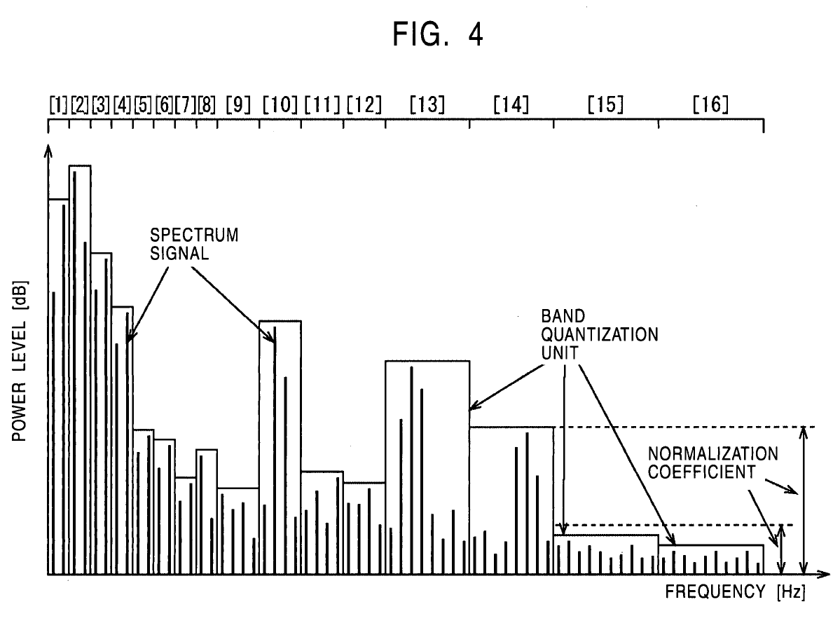

FIG. 4 is a diagram illustrating the absolute value of a spectrum signal obtained by the converting unit 11 using MDCT, in the form of power level. The acoustic wave signal input to the converting unit 11 is converted to, for example, 64 spectrum signals for each predetermined time block. These spectrum signals are divided into 16 bands [1] through [16] as shown in 16 frameworks surrounded by solid lines in the drawing, for example, with later-described processing, and quantization and normalization is performed for each band. This group of spectrum signals divided into 16 bands, i.e., a group of spectrum signals to be quantized and normalized, is a band quantization unit.

Changing quantization precision for each band quantization unit based on how to distribute frequency components enables high-efficiency coding such that audible sound quality deterioration is minimized.

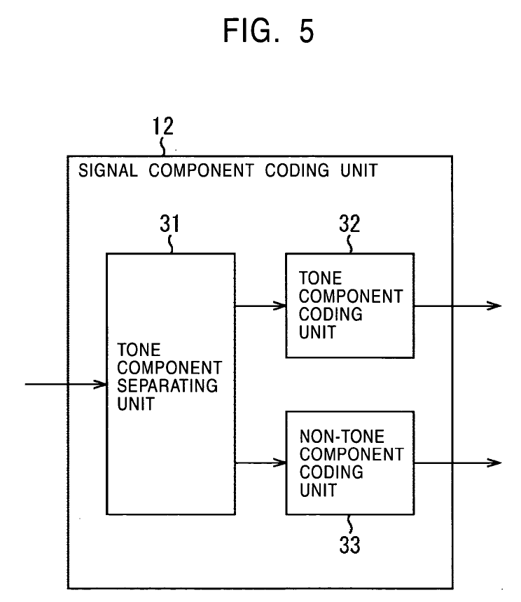

FIG. 5 is a block diagram illustrating a more detailed configuration example of the signal component coding unit 12 in FIG. 2. Here, a case will be described wherein the signal component coding unit 12, separates from a spectrum signal input a tone component particularly important to audibility, i.e., a signal component in which energy concentrates around a specific frequency, and performs coding separately from other spectrum components, for example.

The spectrum signal input from the converting unit 11 is separated into a tone component and a non-tone component by the tone component separation unit 31, and then the tone component is output to a tone component coding unit 32, and the non-tone component is output to a non-tone component coding unit 33 respectively.

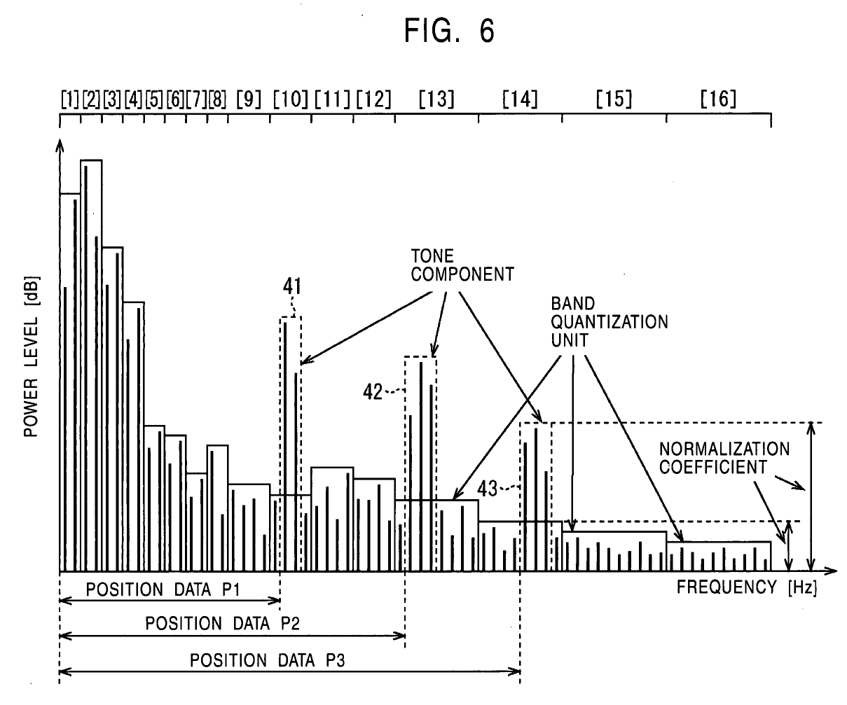

Description will be made here regarding tone components and non-tone components with reference to FIG. 6. For example, in a case that the spectrum signal input to the tone component separation unit 31 is a signal such as shown in FIGS. 4 or 6, the spectrum signal of which the parts having a particularly high power level are separated from non-tone components thereof as tone components 41 through 43. At this time, position data P1 through P3 indicating the positions of the separated tone components 41 through 43, and the frequency widths thereof are detected respectively, and information representing these is output to the tone component coding unit 32 along with the tone components.

As for a method for separating tone components, the method described in the aforementioned Japanese Patent Application No. 5-152865 or WO 94/28633 may be employed. The tone components and the non-tone components separated by this method are quantized with a different number of bits by the processing of the tone component coding unit 32 and the non-tone component coding unit 33, respectively.

Though the tone component coding unit 32 and the non-tone component coding unit 33 each encode signals input thereto, the tone component coding unit 32 performs quantization with a great number of quantization bits, i.e., with high quantization precision, while the non-tone component coding unit 33 performs quantization with a small number of quantization bits as compared with the tone component coding unit 32, i.e., with low quantization precision.

Information such as the position of each tone component, the frequency width extracted as a tone component, and the like, need to be added to respective tone components, thereby enabling the spectrum signal of a non-tone component to be quantized with the small number of bits. In particular, in a case that an acoustic wave signal in which energy concentrates in a specific spectrum is input to the coding device 1, employing this method enables effective coding with a high compression ratio without providing the user with a feeling of deterioration in audibility.

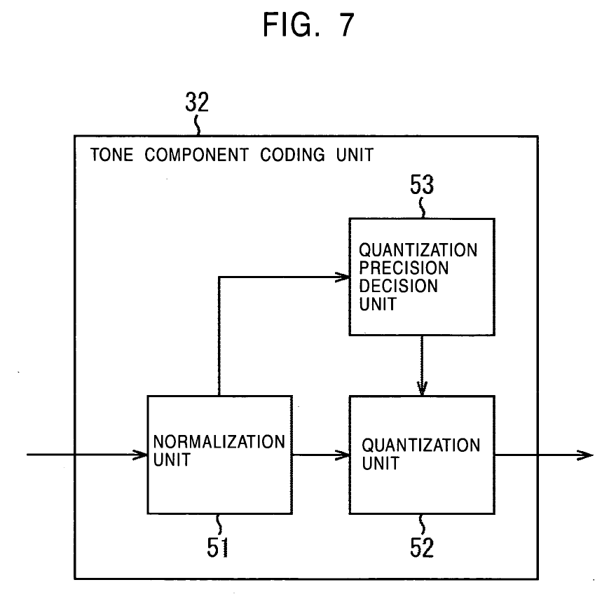

FIG. 7 is a block diagram illustrating a more detailed configuration example of the tone component coding unit 32 in FIG. 5. In response to the spectrum signal of a tone component input, a normalization unit 51 normalizes the spectrum signal for each band quantization unit, and then outputs this to a quantization unit 52. A quantization precision decision unit 53 calculates quantization precision while referring to a band quantization unit input, and then outputs the results to the quantization unit 52. A band quantization unit input is made up of tone components, and accordingly, the quantization precision decision unit 53 decides quantization precision so as to increase the quantization precision. The quantization unit 52 quantizes the normalization results input from the normalization unit 51 with the quantization precision decided by the quantization precision decision unit 53 so as to generate codes, and then outputs coding information, such as normalization coefficient information, quantization precision information, and the like, as well as the code generated. Also, the tone component coding unit 32 encodes the position information of a tone component input along with the tone component as well as the tone component, and then outputs these.

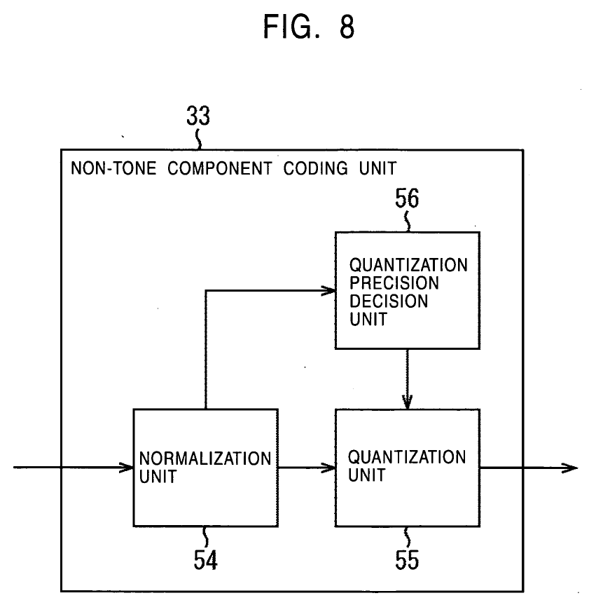

FIG. 8 is a block diagram illustrating a more detailed configuration example of the non-tone component coding unit 33 in FIG. 5. In response to input of the spectrum signal of a non-tone component, a normalization unit 54 normalizes the spectrum signal for each band quantization unit, and then outputs this to a quantization unit 55. A quantization precision decision unit 56 calculates quantization precision while referring to a band quantization unit input, and then outputs this result to the quantization unit 55. A band quantization unit input is made up of non-tone components, and accordingly, the quantization precision decision unit 56 decides quantization precision so as to decrease the quantization precision as compared with a case of a tone component. The quantization unit 55 quantizes the normalization results input from the normalization unit 54 with the quantization precision decided by the quantization precision decision unit 56 so as to generate code, and then outputs coding information, such as normalization coefficient information, quantization precision information and the like as well as the code generated.

Instead of such a coding method, an arrangement may be made wherein variable length coding is performed, and of spectrum signals quantized, spectrum signals frequently used are assigned with a relatively short code length, while spectrum signals infrequently used are assigned with a relatively long code length, thereby further improving coding efficiency.

As described above, while the signal component coding unit 12 separates the signal input into a tone component and a non-tone component so as to perform coding separately and respectively, an arrangement may be made wherein, for example, the non-tone component coding unit 33 in FIG. 8 is employed instead of the signal component coding unit 12, and the signal input is encoded without separating the signal input into a tone component and a non-tone component. In this case, the later-described additional frame has no tone component information thereupon, thereby reducing the amount of the additional data.

Now, returning to FIG. 2, the code stream generating unit 13 generates, for example, a code stream which can be recorded onto a recording medium, or can be transmitted to another information processing device via a data transporting path, i.e., generates a code stream made up of multiple frames from the signal frequency component codes output from the signal component coding unit 12, and then outputs the code stream that has been generated to the data separation unit 14. The code stream generated by the code stream generating unit 13 is audio data playable in high quality sound using a common decoder.

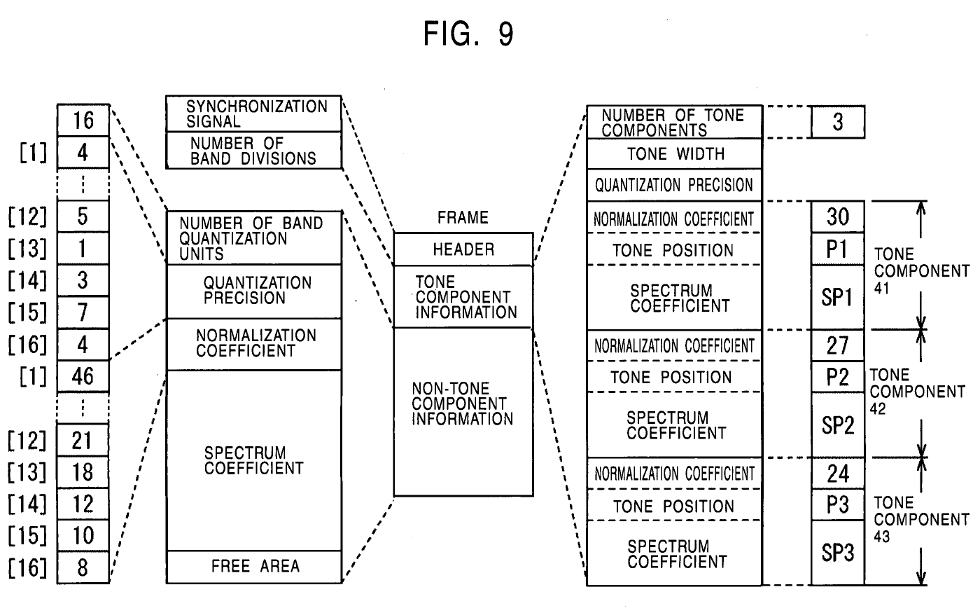

FIG. 9 is a diagram illustrating a frame format example of audio data playable in high-quality sound, generated at the code stream generating unit 13. At the head of each frame is a fixed-length header including a synchronization signal. The header also stores the number of band divisions of the band division filter 21 of the converting unit 11, and the like, described with reference to FIG. 3.

Tone component information regarding the separated tone components is recorded onto each frame subsequently to the header. The number of tone components (for example, 3), tone width, and the quantization precision information of tone components, which are subjected to quantization by the tone component coding unit 32 in FIG. 7, are recorded on the tone component information. Subsequently, the normalization coefficients, the tone positions, and the spectrum coefficients regarding tone components 41 through 43, are recorded.

The following reference characters are used in this example: with the tone component 41, the normalization coefficient is denoted by 30, the tone position is denoted by P1, and the spectrum coefficient denoted by SP1; with the tone component 42, the normalization coefficient is denoted by 27, the tone position by P2, and the spectrum coefficient by SP2; with the tone component 43, the normalization coefficient by 24, the tone position by P3, and the spectrum coefficient by SP3.

Non-tone component information is written on each frame following the tone component information. The number of band quantization units (for example, 16), the quantization precision information, the normalization coefficient information, and the spectrum coefficient information regarding 16 band quantization units of which non-tone components have been encoded by the non-tone component coding unit 33 in FIG. 8, are recorded on the non-tone component information.

In the example shown in FIG. 9, the value 4 of the lowest band quantization unit [1] through the value 4 of the highest band quantization unit [16] are recorded in the quantization precision information for each band quantization unit. The value 46 of the lowest band quantization unit [1] through the value 8 of the lowest band quantization unit [16] are recorded in the normalization coefficient information for each band quantization unit. Here, the value proportionate to the power level value dB of a spectrum signal is employed as the normalization coefficient information thereof. Also, in the event that a frame length is a fixed length, an empty area may be provided at the end of the spectrum coefficient information as shown in FIG. 9.

FIG. 10 is a block diagram illustrating a more detailed configuration example of the data separation unit 14 in FIG. 2. A control unit 61 acquires setting information regarding the sample listening zone and the license information of sample listening data input from an external operating input unit (not shown), and controls a band limit processing unit 62 and a license information generating unit 67 based on the setting information.

The band limit processing unit 62 generates sample listening data, for example, by limiting the coding frame of the original data input to the specified band (sample listening band) based on from the specified position (sample listening start position) and the specified number (sample listening zone length) of the subsequent coding frames in accordance with sample listening zone information (for example, sample listening start position, sample listening zone length, and information specifying sample listening band) input from the control unit 61. For example, of the spectrum data in FIG. 6, the quality of the content to be played can be reduced by minimizing the normalization coefficients of a part of the band quantization units on the high band side, and enabling the frequency bands on the low band side alone to be decoded.

For example, in the event that information that sample listening data is generated with the band quantization units [1] through [12] serving as a sample listening band is input to the control unit 61, the control unit 61 notifies the band limit processing unit 62 that the band quantization units [1] through [12] are included in the sample listening band.

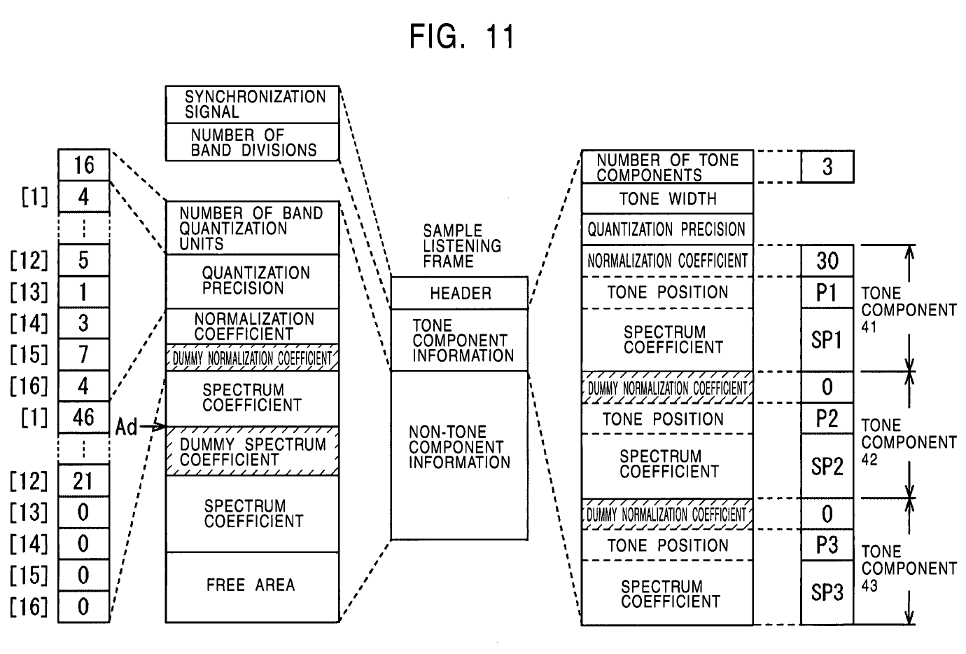

The band limit processing unit 62, in response to this notice, minimizes the value of the normalization coefficient information of the band quantization units [13] through [16] which are not included in the sample listening band, substitutes these with dummy normalization coefficients, and also outputs the original values of the band quantization units [13] through [16] to an additional frame generating unit 64, as shown in FIG. 11.

Accordingly, in the event that instructions have been given to generate sample listening data with the band quantization units [1] through [12] as sample listening bands with regard to the frame shown in FIG. 9, the values 18, 12, 10, and 8 corresponding to the band quantization units [13] through [16] are substituted with zero serving as dummy normalization coefficient information, and also the original values 18, 12, 10, and 8 are output to the additional frame generating unit 64, as shown in FIG. 11.

In the same way as with the case of non-tone components, the band limit processing unit 62 minimizes the normalization coefficients for the tone components which are outside of the sample listening band, of, and also outputs the original values thereof to the additional frame generating unit 64. In an example shown in FIG. 11, the normalization coefficients 27 and 24 (FIG. 9) of the tone components 42 and 43 included in the band quantization units [13] through [16] are minimized, and the values 27 and 24 are output to the additional frame generating unit 64 as the original normalization coefficient values.

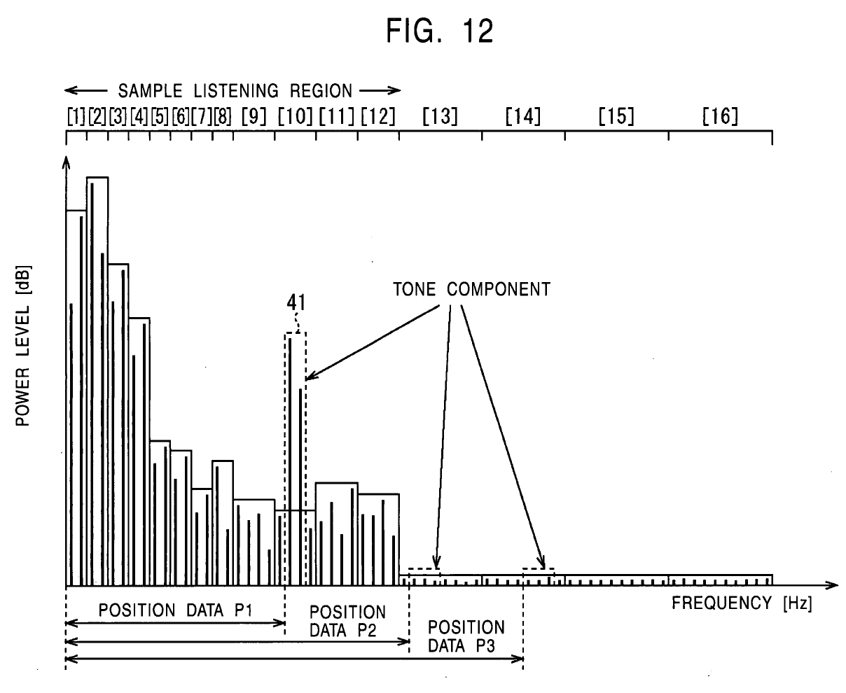

FIG. 12 is a diagram illustrating an example of spectrum signals in the event that the sample listening data shown in FIG. 11 is played, i.e., the normalization coefficients of tone components and non-tone components outside of the sample listening band are substituted with dummy normalization coefficients.

The normalization coefficients information of the band quantization units [13] through [16] out of the coding frame (sample listening frame) of which band is limited is minimized, and accordingly, the non-tone component spectrum signals corresponding to each of the band quantization units are also minimized. Also, with the tone components 42 and 43 included in the band quantization units [13] through [16], the normalization coefficients thereof are minimized, and accordingly, in the same way, the spectrum signals corresponding to these are also minimized. That is to say, in the event that the sample listening data is decoded so as to be played, the narrow band spectrum signals of the band quantization units [1] through [12] are played.

In the example in FIG. 11, while description has been made regarding a case wherein the sample listening band is the band quantization units [1] through [12], the sample listening band may be set so as to be modified differently for each frame. Also, sample listening frames may be set as a soundless frame by minimizing the normalization coefficients of all of the non-tone components and the tone components (i.e., the sample listening band is set to zero).

As described above, the processing for generating sample listening frames by reducing the original coding frames to low-quality frame streams may be applied to all of the coding frames, or to the frames of a part of zones within the content or the frames of multiple zones.

Also, in the event that the frame streams of one or more zones are reduced to low-quality frame streams, the frames out of the specified zones are subjected to the above-described processing for modifying the frames to soundless frames for example, thereby preventing the original coding frames from being included in the sample listening data.

Thus, in a case of playing the sample listening data, the data is played in the narrow-band sound quality only, or without sound, whereby low-quality sound is output as compared with a case of playing the original data in FIG. 9.

Minimizing the normalization coefficients of non-tone components also minimizes the corresponding spectrum coefficient information on the band higher than the position indicated by the position “Ad” in FIG. 11 at the time of playing the sample listening data, whereby arbitrary information can be written in this region.

That is to say, a spectrum coefficient information modifying unit 63 shown in FIG. 10 writes random dummy data in the region of the band higher than the position indicated by the position Ad in FIG. 11, and then outputs this to a sample listening data generating unit 65 as a sample listening frame. Furthermore, the spectrum coefficient information modifying unit 63 outputs the original spectrum coefficient information on the part where the dummy data is written, and information representing the position where the dummy data is written, to an additional frame generating unit 64 as necessary.

Note that processing for extracting spectrum coefficient information may be applied to all the frames, or may be applied to an arbitrary part of the frames only.

In particular, in the event that the spectrum coefficient information subjected to variable length coding is sequentially recorded from the low band side to the high band side, other information is recorded on the region of the spectrum coefficient information to be minimized at the time of decoding, and accordingly, a part of variable length codes on the middle band lack, whereby the data on the band higher than the middle band including that part cannot be completely decoded. That is to say, it becomes very difficult to restore the spectrum coefficient information on the band higher than the sample listening band included in the sample listening data without employing the true values to be written to the additional data, thereby strengthening the security of the sample listening data.

As described above, in the event that a part of the normalization coefficient information lacks, a part of the spectrum coefficient information is substituted with other information, and it is very difficult to assume the true data even in comparison with decoding a cryptographic key with a comparatively short key length employed in common contents distribution systems. Moreover, unauthorized attempts to modify the sample listening data results in further sound quality deterioration.

Therefore, it becomes very difficult for a user who has not been permitted to play the original data to assume the original data based on the sample listening data, thereby protecting the rights of content authors and distributors in more reliable manner.

Also, even if the true data should be assumed in certain sample listening data, the damage does not extend to other contents, unlike cases of decoding cryptographic algorithms, thereby obtaining higher security than with methods for distributing contents data subjected to encryption using a specific algorithm as sample listening data.

As described above, the true values of the normalization coefficient information of the non-tone components and the tone components modified by the band limit processing unit 62, and the true values of a part of the spectrum coefficient information of the non-tone components extracted by the spectrum coefficient information modifying unit 63, are supplied to the additional frame generating unit 64, so as to be written in the additional data.

Note that instead of modifying the normalization coefficient information of the band quantization units outside of the sample listening band, or at the same time as modifying the normalization coefficient information, the quantization precision information of the band quantization units outside of the sample listening band may be modified by minimizing this, in this case, the band limit processing unit 62 outputs the true values of the quantization precision information modified to the additional frame generating unit 64 as well as the values of the normalization coefficient information.

However, a case of modifying the normalization coefficient information and a case of modifying the quantization precision information are different with regard to the difficulty for unauthorized assuming of the original data from the sample listening data without using the additional data, i.e., in the security strength of the sample listening data. For example, in the event that a bit allocation algorithm is employed to calculate the quantization precision information based on the normalization coefficient information at the time of generating the original data, modifying only the quantization precision information outside of the sample listening band while the normalization coefficient information is still written in the sample listening data, poses a risk that the true quantization precision information may be assumed using this normalization coefficient information as a clue.

On the other hand, it is difficult to assume the normalization coefficient information from the quantization precision information, and accordingly, even if only the normalization coefficient information is modified, the security strength of the sample listening data is still high.

Moreover, modifying both the values of the normalization coefficient information outside of the sample listening band and the quantization precision information removes a risk for unauthorized assuming of the original data. It is needless to say that the normalization coefficient information outside of the sample listening band and the quantization precision information may be selectively modified using the frames of the sample listening data.

Returning to FIG. 10, the additional frame generating unit 64 generates a frame (additional frame) for making up additional data for modifying the sample listening data to obtain high-quality sound based on the normalization coefficient information outside of the sample listening band and the quantization coefficient information input from the band limit processing unit 62 for each frame of the original data, and the spectrum coefficient information outside of the sample listening band input from the spectrum coefficient information modifying unit 63.

As described above with reference to FIG. 11, assuming that the sample listening band of the sample listening zone is the band quantization units [1] through [12], with each frame within the sample listening zone of the sample listening data, the normalization coefficient information (the shaded portion in FIG. 11) of the two tone components (tone components 42 and 43) included in the band quantization units [13] through [16], and the normalization coefficient information (the shaded portion in FIG. 11) of the four non-tone components are substituted with minimized dummy data, and then the true values thereof are written in the additional frame. A part of the spectrum coefficient information (the shaded portion in FIG. 11) of the non-tone components of the band quantization units [13] through [16] outside of the sample listening band is also substituted with the dummy data, and then the true values thereof are written in the additional frame.

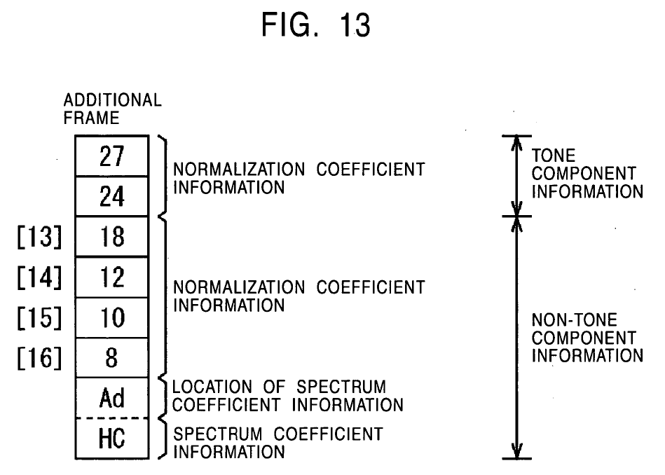

FIG. 13 is a diagram illustrating a format example of the additional frame generated by the additional frame generating unit 64. In FIG. 13, an example of the additional frame corresponding to the sample listening frame in FIG. 11 is illustrated.

As for information regarding tone components, the value 27 of the true normalization coefficient information of the tone component 42 substituted with the dummy data, and the value 24 of the true normalization coefficient information of the tone component 43, are each written in the additional frame.

Moreover, as for information regarding non-tone components, the values 18, 12, 10, and 8 of the true normalization coefficient information of the band quantization units [13] through [16] outside of the sample listening band substituted with the dummy data, and the spectrum coefficient information value HC of the part substituted with the dummy data, and the position Ad thereof, are written in the additional frame.

In the example shown in FIG. 13, while description has been made wherein the position information of the spectrum coefficient information substituted with the dummy data in the sample listening frame is written in the additional frame, the position information may be omitted from the additional frame. In this case, the position of the spectrum coefficient information substituted with the dummy data may be obtained from the position of the normalization coefficient information (the number of the band quantization units) substituted with the dummy data, of the normalization coefficient information of non-tone components, by setting the position of the spectrum coefficient information to be substituted with the dummy data to the head of the spectrum coefficient information outside of the sample listening band.

On the other hand, the position of the spectrum coefficient information to be substituted with the dummy data may be any position backward (lower) from the head of the spectrum coefficient information outside of the sample listening band, and in this case, there is the need to write the position information of the spectrum coefficient information substituted with the dummy data in the additional frame as shown in FIG. 13.

Moreover, the amount of the additional data can be reduced by writing a part of the additional data in the empty area of the sample listening frame. In this case, in the event that a user attempts to download the additional data, the communication time can be reduced.

The sample listening data generating unit 65 shown in FIG. 10 generates the header of the distribution data, and then generates the sample listening data by adding the header to the sample listening frame stream supplied. The header of the distribution data includes, for example, a content ID for identifying a content, playing time for a content, title of a content, information regarding a coding method, and the like. The sample listening data generated by the sample listening data generating unit 65 is output to the license information generating unit 67.

An additional data generating unit 66 generates additional data from an additional frame stream input, and then outputs the generated additional data to the license information generating unit 67.

The license information generating unit 67 encapsulates the sample listening data supplied from the sample listening data generating unit 65, the additional data supplied from the additional data generating unit 66, which is enciphered as necessary, and the license information, based on setting information of the license information supplied from the control unit 61.

The license information may include information stipulating content-use conditions such as use expiration date, period of time for use, number of times for use, usage time, and the like. For example, as for the additional data of the distribution data of a content C, use of the content C can be restricted by specifying the additional data which can be used in a case of satisfying a certain condition A, and the additional data which can be used in a case of not satisfying the condition A with the license information. Specifically, the license information can be set such that in the event of satisfying the conditions “use of the content C enabled prior to the use expiration date Dₗᵢₘᵢₜ” (in the event that a user attempts to play the content C prior to the use expiration date Dₗᵢₘᵢₜ), the content C can be played using all the additional frames; otherwise (in the event that the user attempts to play the content C following the use expiration date Dₗᵢₘᵢₜ), none of the additional frames cannot be used, thereby restricting the use of the content C.

Furthermore, a complex condition may be set to the license information as follows. For example, in the event that a condition B is set such that the content can be used within the number of times for use Nₘₐₓ and prior to the use expiration date Dₗᵢₘᵢₜ, the use of the content can be restricted if the condition B is not satisfied, i.e., in a case of exceeding the number of times for use Nₘₐₓ or exceeding the use expiration date Dₗᵢₘᵢₜ. In the same way, in the event that a condition C is set such that a content can be used within the number of times for use Nₘₐₓ or prior to the use expiration date Dₗᵢₘᵢₜ, the use of the content can be restricted if the condition C is not satisfied, i.e., in a case of exceeding the number of times for use Nₘₐₓ and exceeding the use expiration date Dₗᵢₘᵢₜ.

As described above, the license information applied to the distribution data is for stipulating use conditions of the distribution data. Accordingly, a user who possesses the distribution data can obtain contents having rights of the unlimited number of times for use and an unlimited expiration date by restoring the original data from the sample listening data and the additional data, and then purchasing license information for recording the original data. Moreover, the user can extend the use expiration date of the original data by purchasing license information which can extend the use expiration date of the original data.

The original data can be restored as described later, using distribution data generated by the data separation unit 14 configured as described above.

Next, description will be made regarding a specific example of the distribution data including the sample listening data and the additional data. FIG. 14 is a diagram illustrating an example format of the distribution data. The distribution data shown in FIG. 14 comprises a content header including a content ID (CID); sample listening data comprising sample listening frames M1 through M8; and additional data comprising additional frames S1 through S8 in which license information LIC is inserted.

The sample listening frames M1 through M8 are made up of the coding frames of the original data of which quality is reduced by setting a sample listening band or the like, as described above. Also, the respective sample listening frames M1 through M8 correspond to the additional frames S1 through S8 respectively, so that the original data can be restored from the sample listening frames using the additional frames S1 through S8. That is, each additional frame includes data required for restoring the corresponding each sample listening frame to the coding frame of the original data.

The license information LIC of the distribution data includes one or more license conditions, and in this example, limit of time for playing Dₗᵢₘᵢₜ, number of play times Pₘₐₓ, accumulated playing time Tₘₐₓ, number of copies Cₘₐₓ, and number of times for recording Rₘₐₓ, are set as license conditions.

The limit of time for playing Dₗᵢₘᵢₜ represents the period of time wherein the distribution data can be played in high-quality sound, and a value representing invalidity is set here. In the event that the invalid value is set to the limit of time for playing Dₗᵢₘᵢₜ, this means that this distribution data cannot be played in high-quality sound.

The number of play times Pₘₐₓ represents the maximum number of times for playing the distribution data in high-quality sound, and the value zero is set here, which means that this distribution data cannot be played in high-quality sound.

The accumulated playing time Tₘₐₓ represents the maximum accumulated time for playing the distribution data in high-quality sound, and the value zero is set here, which means that this distribution data cannot be played in high-quality sound.

The number of copies Cₘₐₓ represents the maximum number of times for copying the distribution data to another apparatus, and the value representing an unlimited number is set here, which means that this distribution data can be copied any number of times without modification (without restoring to the original data).

The number of times for recording Rₘₐₓ represents the maximum number of times for recording the distribution data in high-quality sound, and the value zero is set here, which means that this distribution data cannot be recorded in high-quality sound.

Now, the above term “copy” means the so-called checkout wherein the original data can be used with another apparatus while managing the copyrights, and “recording” means that the original data (without any modification) is duplicated onto a recording medium such as a CD-R or the like. Note that in the event that the distribution data is copied, the original data in high-quality sound is recorded, or the like, the license information on which the above-described various conditions are written, is overwritten, copied, or recorded as necessary.

FIG. 14 illustrates a situation wherein only the sample listening data of which sound quality is restricted is played because playing in high-quality sound is restricted due to the license conditions. Such distribution data is distributed as commercial content by the coding device 1, whereby the user can grasp the overall image of the entire content, though sound quality thereof is inferior to that of the original data. Also, in the event that the user is satisfied with the content, the user pays the price so as to update the license information for playing the original data, or obtains the license information for recording (restoring) the original data, thereby using the original data.

Next, description will be made regarding a specific example of high-quality sound data (original data) to be restored based on the distribution data.

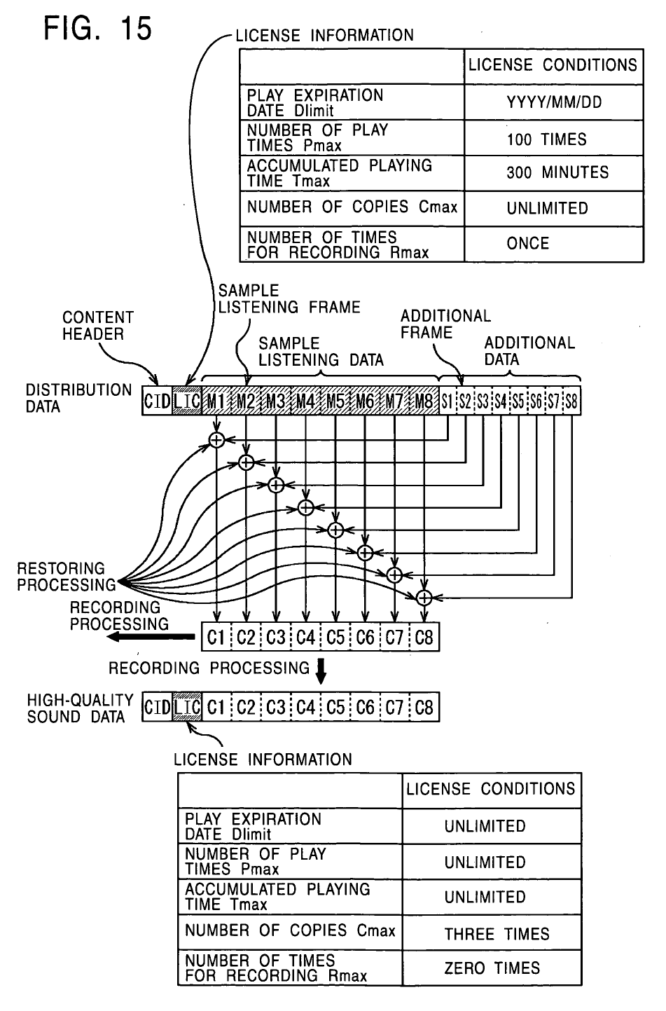

FIG. 15 is a diagram illustrating the format of the distribution data and a format example of high-quality sound data to be restored based on the distribution data. In the event that a user who has obtained distribution data listens to the sample listening data included in the distribution data, and is satisfied with the content, the user can update the license information by paying a the price thereof using a predetermined method. For example, in the event that the contents provider has a fixed-charge content-use service, the user can update the license of the distribution data shown in FIG. 15 from the license information of the distribution data shown in FIG. 14 by paying a predetermined monthly charge using a credit card or cybermoney, or via the service provider.

In an example shown in FIG. 15, the period of time for playing Dₗᵢₘᵢₜ indicates that this distribution data can be played in high-quality sound until yyyy/mm/dd, the number of play times Pₘₐₓ indicates that this distribution data can be played 100 times in high-quality sound. Moreover, the accumulated playing time Tₘₐₓ indicates that this distribution data can be played in high-quality sound for 300 minutes, the number of copies Cₘₐₓ indicates that this distribution data can be copied any number of times. Furthermore, in an example shown in FIG. 15, the number of times for recording Rₘₐₓ indicates that the distribution data can be played in high-quality sound only once. However, in the event that the distribution data is copied, the license information is overwritten or copied or recorded as necessary when recording the distribution data in high-quality sound.

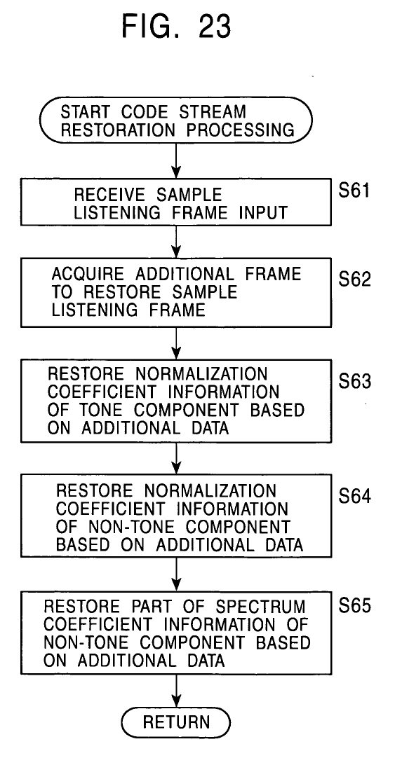

The data playing device 5 can play the distribution data in high-quality sound due to the updated license information. That is to say, the data playing device 5 can generate coding frames C1 through C8 of the original data by performing later-described restoration processing (FIG. 23) based on the sample listening frames M1 through M8 included in the sample listening data in FIG. 15, and the additional frames S1 through S8 included in the additional data which correspond to the sample listening frames M1 through M8 respectively. Subsequently, the data playing device 5 can play the distribution data in high-quality sound by applying the later-described playing processing (FIG. 22) to the obtained coding frames.

However, the original data generated based on the license conditions of the license information including the limit of time for playing Dₗᵢₘᵢₜ, the number of play times Pₘₐₓ, and the accumulated playing time Tₘₐₓ, is subjected to the playing processing in real time without recording the original data onto a recording medium possessed by the user, and then is output in analog data from the data playing device 5. In other words, the license conditions are set such that the distribution data can be played in high-quality sound, but the high-quality sound data itself cannot be recorded onto a recording medium, thereby protecting the high-quality content from unauthorized copying, so the contents provider can provide fixed-charge contents-use services wherein a user can play a content in high-quality sound any number of times as long as within a predetermined limit of time.

It is also possible to prevent the distribution data from being played in high-quality sound in a case that any one of the license conditions written in the license information i.e., the limit of time for playing, the number of play times, and the accumulated playing time, is no longer satisfied, or in a case that all of the license conditions are no longer satisfied. In other words, it is possible to restrict playing in high-quality sound in accordance with various combinations of each license condition.

Note that, as for license conditions of the license information, various conditions can be conceived besides the above-described conditions. For example, the period of time for playing, which indicates the period of time for playing the distribution data in high-quality sound, can be set as a license condition of the license information.

As described above, in a case that the license conditions of the license information include the limit of time for playing, determination may be made whether or not the license condition is satisfied using a calendar function, or in a case that the license conditions include the period of time for playing, determination may be made whether or not the license condition is satisfied using the calendar function and a timer function. Alternately, in a case that the license conditions include the accumulated playing time, determination may be made whether or not the license condition is satisfied using the timer function and a memory function, and in a case that the license conditions include the number of play times, determination may be made whether or not the license condition is satisfied using a counter function and the memory function.

As described above, in the event that a user who has obtained distribution data listens to the sample listening data included in the distribution data, and is satisfied with the content, the user can obtain the license information for recording high-quality sound data (original data) onto a recording medium by paying the price using a predetermined method, thereby enabling the high-quality sound data to be recorded onto a recording medium as well. Specifically, the user can record the high-quality sound data onto a recording medium by updating the license information from the license information of the distribution data shown in FIG. 14 to the license information shown in FIG. 15. When the high-quality sound data is recorded onto a recording medium, the license information of the distribution data is overwritten with the license information for high-quality sound data, as shown in the lower portion of FIG. 15.

FIG. 15 illustrates an example of high-quality sound data comprising a content header including a content ID (CID); and coding frame streams C1 through C8 modified in high-quality sound in which updated license information LIC is inserted. That is to say, in this example, the coding frames C1 through C8 of the original data may be generated by performing the later-described restoration processing (FIG. 23) based on the sample listening frames M1 through M8 included in the sample listening data, and the additional frames S1 through S8 included in the additional data which correspond to the sample listening frames M1 through M8 respectively. Subsequently, recording the high-quality sound data onto a recording medium may be realized by applying the later-described recording processing (FIG. 25) to the obtained coding frames, content header, and license information.

Also, when recording the high-quality sound data, the license information of the distribution data updated as the license information for high-quality sound data (the license information shown at the lower portion of FIG. 15) is recorded. With the license information for high-quality sound shown in the lower portion of FIG. 15, the limit of time for playing Dₗᵢₘᵢₜ, the number of play times Pₘₐₓ, and the accumulated playing time Tₘₐₓ indicates that the high-quality sound data can be played in an unlimited manner, the number of copies Cₘₐₓ indicates that this high-quality sound data can be copied three times only, and the number of times for recording Rₘₐₓ indicates that further high-quality sound recording cannot be performed because recording in high-quality sound has been performed once. Thus, when the distribution data is recorded in high-quality sound, the content of the license information is overwritten and recorded as necessary.

In a case that it is permitted to copy the recorded high-quality sound data, the number of copies Cₘₐₓ of the license information thereof is overwritten with “zero times” for the high-quality sound data at the destination of copying, thereby preventing the high-quality sound data to be copied from the destination of copy to further another apparatus or recording medium.

In the above description, while a case has been described wherein all of the coding frames of the content data are separated into the sample listening frames and the additional frames, an arrangement may be made wherein a part of the sample listening frames included in the sample listening data are used as the coding frames (high-quality-sound sample listening frames) of the original data. In this case, there are no additional frames corresponding to the high-quality-sound sample listening frames. Therefore, it is also possible for the arbitrary multiple positions of the sample listening data to include the high-quality-sound sample listening frame by recording the corresponding relation between the sample listening frames and the additional frames onto the content header.

Next, description will be made regarding the processing for generating distribution data performed by the data separation unit 14 in FIG. 10 with reference to the flowchart in FIG. 16.

In Step S1, the control unit 61 of the data separation unit 14 acquires setting values (setting information) regarding the sample listening zone representing the sample listening start position, the sample listening zone length, the sample listening band, and the like input from a operating input unit (not shown) or the like.

Here, as described above with reference to FIG. 11 and FIG. 12, description will be made with an arrangement wherein the band quantization units [1] through [12] are set as the sample listening band, the head of the content is set as the sample listening start position, and the length of the entire content is set as the sample listening zone length. That is to say, in this arrangement, all of the coding frames are set so as to be restricted with the band quantization units [1] through [12]. The control unit 61 supplies the setting value of the sample listening zone to the band limit processing unit 62.

In Step S2, the band limit processing unit 62 sequentially receives any of the frames included in the frame stream corresponding to the original data, i.e., the frames capable of high-quality sound play described with reference to FIG. 9.

In Step S3, in a case that the band limit processing unit 62 determines that the coding frame input is included in the sample listening zone based on the setting value of the sample listening zone supplied in the processing in Step S1 (in a case that the sample listening data is made up of the coding frames input), the band limit processing unit 62 performs minimization by substituting the values of the normalization coefficients of the tone components outside of the sample listening band with the dummy value zero (dummy data), for example. Thus, the spectrum coefficients of the tone components outside of the sample listening band are minimized at the time of the processing for playing the coding frames.

On the other hand, in a case that the band limit processing unit 62 determines that the coding frame input is not included in the sample listening zone, the band limit processing unit 62 performs minimization by substituting all of the values of the normalization coefficients of the tone components with the dummy value zero (dummy data) for example. Thus, all of the spectrum coefficients of the tone components are minimized at the time of the processing for playing the coding frames.

At this time, the band limit processing unit 62 supplies the true values of the normalization coefficients information of the tone components substituted with the dummy data to the additional frame generating unit 64 because these values are written in the additional data by the additional frame generating unit 64 in the later-described processing in Step S6.

In Step S4, in a case that the band limit processing unit 62 determines that the coding frame input is included in the sample listening zone, the band limit processing unit 62 performs minimization by substituting the values of the normalization coefficients of the non-tone components outside of the sample listening band with the dummy value zero (dummy data) for example. Thus, the spectrum coefficients of the non-tone components outside of the sample listening band are minimized at the time of the processing for playing the coding frames.

On the other hand, in a case that the band limit processing unit 62 determines that the coding frame input is not included in the sample listening zone, the band limit processing unit 62 performs minimization by substituting all of the values of the normalization coefficients of the non-tone components with the dummy value zero (dummy data), for example. Thus, all of the spectrum coefficients of the non-tone components are minimized at the time of the processing for playing the coding frames.

At this time, the band limit processing unit 62 supplies the true values of the normalization coefficients information of the non-tone components substituted with the dummy data to the additional frame generating unit 64 because these values are written in the additional data by the additional frame generating unit 64 in the later-described processing in Step S6.

In Step S5, in a case that the spectrum coefficient information modifying unit 63 determines that the coding frame input is included in the sample listening zone, the spectrum coefficient information modifying unit 63 substitutes a part of the spectrum coefficient information of the non-tone components on the band higher than the sample listening band with the dummy value such as a value of which the true value cannot be assumed, if necessary.

On the other hand, in a case that the spectrum coefficient information modifying unit 63 determines that the coding frame input is not included in the sample listening zone, the spectrum coefficient information modifying unit 63 substitutes a part of the spectrum coefficient information of the arbitrary non-tone components with the dummy value such as a value of which the true value cannot be assumed, if necessary, and supplies the true values to the additional frame generating unit 64 because these values are written in the additional data by the additional frame generating unit 64 in the later-described processing in Step S6.

In Step S6, the additional frame generating unit 64 writes the normalization coefficient information of the tone and non-tone components and the normalization coefficient information of the non-tone components input from the band limit processing unit 62, and a part of the spectrum coefficient information of the non-tone components input from the spectrum coefficient information modifying unit 63 in the additional frame as shown in FIG. 13 so as to generate the additional data.

Following the processing in Step S6, the control unit 61 determines whether or not the last-processed frame (the frame processed in Step S2 through S6) is the final frame of the sample listening data in Step S7. In Step S7, in the event that determination has been made that the last-processed frame is not the final frame (No), the flow returns to Step S2, and then the subsequent processing is repeated.

On the other hand, in Step S7, in the event that determination has been made that the last-processed frame is the final frame (Yes), the flow proceeds to Step S8, where the sample listening data generating unit 65 generates a header of the distribution data, and then supplies the header to the license information generating unit 67 along with the sample listening frame streams.

In Step S9, the control unit 61 acquires the setting value of the license information input from the operating input unit (not shown) or the like, and then supplies this to the license information generating unit 67.

In Step S10, the license information generating unit 67 integrates the header and the sample listening data supplied from the sample listening data generating unit 65, and the additional data supplied from the additional data generating unit 66 based on the setting value of the license information supplied from the control unit 61, and then add the license information thereupon as shown in FIG. 14. Thus, the processing for generating the sample listening data is completed.

The sample listening data thus generated is, for example, distributed to a user via the computer network 4 in FIG. 1, or is distributed so as to be recorded onto a various recording medium possessed by a user using MMK equipped in a store, or the like. In the event that a user listens to the sample listening data included in the distribution data, and is satisfied with the content (original data), the user can purchase the license information for playing or recording the content in high-quality sound by paying the price thereof to the content provider, or the like, so as to update the license conditions stipulated by the license information. The user modifies the distribution data to high-quality sound data so as to restore the original data within the range of the license conditions updated, thereby allowing the user to decode and play the high-quality sound data, or to record the high-quality sound data onto a predetermined recording medium.

Next, description will be made regarding the configuration of the data playing device 5 in FIG. 1 for processing the distribution data thus generated and the operation thereof. FIG. 17 is a block diagram illustrating a configuration example of the data playing device 5.

A code stream separation unit 91, in response to the sample listening frame input included in the sample listening data, disassembles the code stream so as to extract the code of each signal component, and then outputs the obtained code to a code stream restoration unit 93.

A control unit 92 controls an additional data input unit 96, the code stream restoration unit 93, and a license information control unit 97, in response to the instruction for playing the data input to the code stream separation unit 91, or the like by a user operating the operating input unit (not shown), or information input for updating the license information of the distribution data.

The control unit 92 controls the additional data input unit 96 to obtain the license information of the distribution data in a case of playing the distribution data. The control unit 92 supplies the license information obtained to the license information control unit 97 so as to cause the license information control unit 97 to retain the license information of the distribution data.

The control unit 92 determines whether or not the distribution data to be played can be played in high-quality sound, by referring to the license information retained by the license information control unit 97. Here, in the event that the play expiration date is set as the license condition for high-quality sound play, the control unit 92 compares the value of the license information with the value of a timing unit 98, and then permits high-quality sound play when the date of the timing unit 98 is equal to or earlier than the date of the license information, or prohibits when the date of the timing unit 98 elapses the date of the license information.

In a case that the high-quality sound play of the distribution data is prohibited, the control unit 92 controls a license information acquisition unit (not shown) to acquire the new license information in accordance with the instructions by the user for updating the license information of the distribution data. Thus, the control unit 92 controls the license information control unit 97 so as to substitute the license information of the distribution data shown in FIG. 14 with the license information of the distribution data shown in FIG. 15, for example. Moreover, the control unit 92 controls the code stream restoration unit 93 to supply the coding frames of the sample listening data without any modification supplied from the code stream separation unit 91 to a signal component decoding unit 94.

On the other hand, in a case that the high-quality sound play of the distribution data is permitted, the control unit 92 controls the additional data input unit 96 to acquire the additional data. The control unit 92 supplies the additional data acquired to the code stream restoration unit 93 so as to cause the code stream restoration unit 93 to modify the sound of the sample listening frames to high-quality sound. Here, the additional data input unit 96 separates and obtains the additional data included in the distribution data under control of the control unit 92, and in a case that the additional data is enciphered, decodes this so as to supply this to the control unit 92 as the additional frame stream.

That is to say, in a case of high-quality sound play, the code stream restoration unit 93 restores the sample listening frames supplied from the code stream separation unit 91 to the coding frames of high-quality sound data using the additional frames supplied from the control unit 92, and then outputs the coding frames restored to the signal component decoding unit 94.

In a case that high-quality sound play of the content data is restricted by the number of play times and the accumulated playing time, the control unit 92 controls the license information control unit 97 to update the number of play times by counting the current number of play times using a counter, or to update the accumulated playing time by timing the current playing time using a timing unit 98.

On the other hand, in a case that high-quality sound play is not performed without obtaining the original data from the sample listening data, the control unit 92 controls the code stream restoration unit 93 to play the sample listening data without obtaining the additional data from the additional data input unit 96. At this time, the code stream restoration unit 93 supplies the coding frames of the sample listening data supplied from the code stream separation unit 91, without any modification, to the signal component decoding unit 94.

The signal component decoding unit 94 decodes the sample listening data input or the coding frames of the high-quality sound data, and then outputs the result decoded to an inverse conversion unit 95.

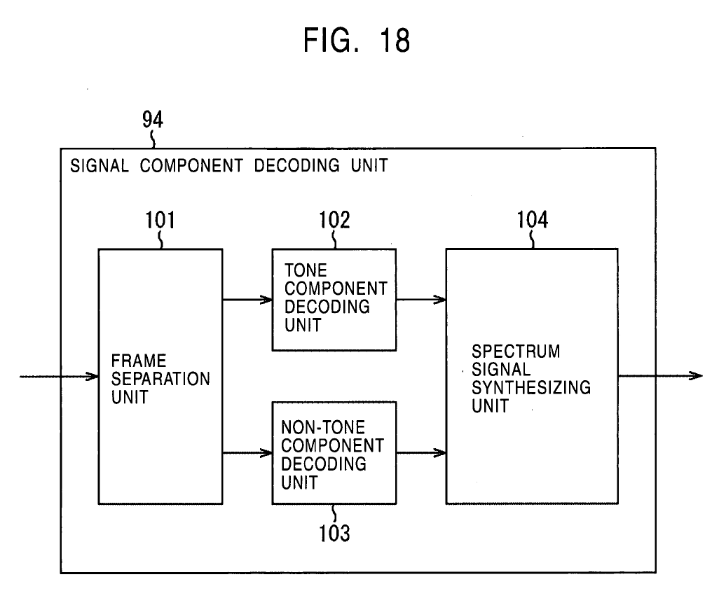

FIG. 18 is a block diagram illustrating a detailed configuration example of the signal component decoding unit 94, in a case that a coding frame is encoded by being separated into a tone component and a non-tone component, for decoding the coding frame.

A frame separation unit 101, in response to the coding frame input as described with reference to FIG. 9 and FIG. 11 for example, divides the frame into a tone component and a non-tone component, and then outputs the tone component to a tone component decoding unit 102 and the non-tone component to a non-tone component decoding unit 103 respectively.

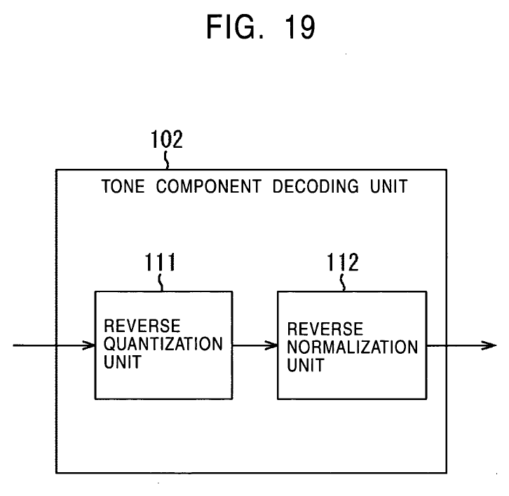

FIG. 19 is a block diagram illustrating a more detailed configuration example of the tone component decoding unit 102. A reverse quantization unit 111 quantizes coding data input reversely so as to output this to a reverse normalization unit 112. The reverse normalization unit 112 normalizes data input reversely. That is to say, decoding processing is performed using the reverse quantization unit 111 and the reverse normalization unit 112, resulting in outputting the spectrum signal of the tone component.

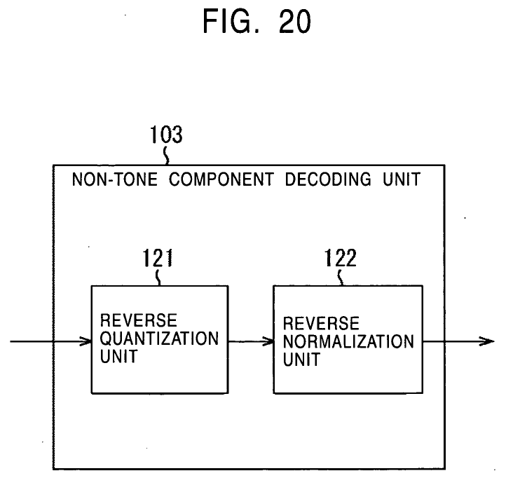

FIG. 20 is a block diagram illustrating a more detailed configuration example of the non-tone component decoding unit 103. A reverse quantization unit 121 quantizes coding data input reversely so as to output this to a reverse normalization unit 122. The reverse normalization unit 122 normalizes data input reversely. That is to say, decoding processing is performed using the reverse quantization unit 121 and the reverse normalization unit 122, resulting in outputting the spectrum signal of the non-tone component.

A spectrum signal synthesizing unit 104 shown in FIG. 18, in response to the spectrum signals input which are output from the tone component decoding unit 102 and the non-tone component decoding unit 103, synthesizes these signals, determines whether or not the signal input is high-quality sound data, generates a spectrum signal such as described with reference to FIG. 6 in the case of high-quality sound data, generates a spectrum signal such as described with reference to FIG. 12 in the case of sample listening data, and then outputs the spectrum signal to the inverse conversion unit 95 (FIG. 17).

Note that in the event that coding data is not separated into a tone component and a non-tone component at encoding, decoding processing may be performed using either the tone component decoding unit 102 or the non-tone component decoding unit 103, excluding the frame separation unit 101.

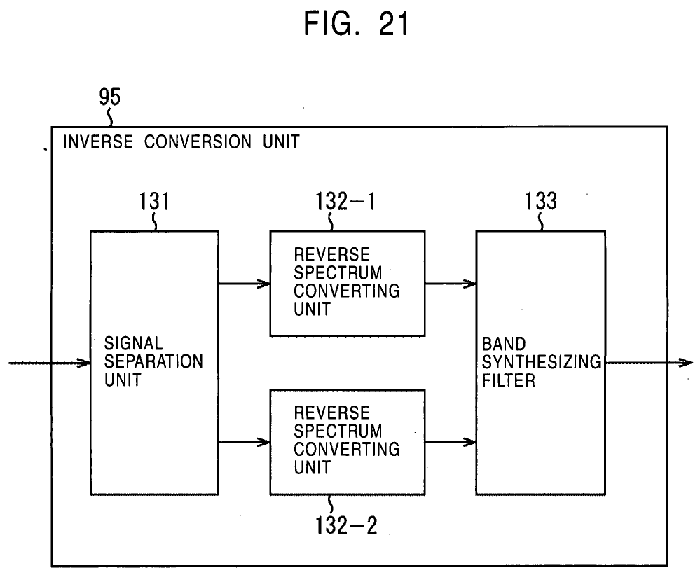

FIG. 21 is a block diagram illustrating a more detailed configuration example of the inverse conversion unit 95 in FIG. 17. The signal separation unit 131 separates a signal based on the number of band divisions written in the header of the coding frame input. The number of band divisions is two here, and accordingly, the signal separation unit 131 separates the spectrum signal input into two bands, and then outputs the separated signals to inverse spectrum conversion units 132-1 and 132-2 respectively.

The inverse spectrum conversion units 132-1 and 132-2 apply inverse spectrum conversion to the input spectrum signals, and then outputs the signals of each band obtained to a band synthesizing filter 133. The band synthesizing filter 133 synthesizes the signals of each band input, and then outputs the signal synthesized.

The signal (for example, audio PCM signal) output from the band synthesizing filter 133 is converted into an analog signal at a D/A (Digital to Analog) conversion unit (not shown) for example, and is output to a speaker so as to be played as audio. Also, an arrangement may be made wherein the signal output from the band synthesizing filter 133 is output from another device via a network or the like.

Next, description will be made regarding data playing processing executed by the data playing device 5 in FIG. 17 with reference to the flowchart in FIG. 22.

In Step S41, the control unit 92 controls the additional data input unit 96 to acquire the additional data. That is to say, the additional data input unit 96, in response to the additional data input, identifies the additional frame streams of the additional data in accordance with control from the control unit 92, and then supplies these to the control unit 92. The additional data is, for example, acquired from the distribution server 2 by the additional data input unit 96 via the computer network 4.

In Step S42, the control unit 92 acquires the license information from the additional data input unit 96, and also controls the license information control unit 97 to retain the license information acquired. In a case that high-quality sound playing of the distribution data is prohibited, the control unit 92, in response to the request from the user, acquires the new license information for updating the license information of the distribution data, and then controls the license information control unit 97 to update the license information therein. In the example shown in FIG. 14, the license information of the distribution data is substituted with the license information of the distribution data shown in FIG. 15.

Also, the control unit 92 acquires the content header from the additional data input unit 96, identifies the sample listening frames included in the sample listening data which can be played in high-quality sound based on the license information. In the case of the example shown in FIG. 14, the sample listening frames M1 through M8 are identified as the coding frames which can be played in high-quality sound.

In Step S43, the code stream separation unit 91, in response to the sample listening frames input included in the sample listening data, disassembles the code streams input, and then output these to the code stream restoration unit 93 in Step S44. In the example shown in FIG. 14, the sample listening frames M1 through M8 are sequentially input to the code stream restoration unit 93.

In Step S45, the control unit 92 determines whether or not high-quality sound playing is permitted in the license information retained by the license information control unit 97, in a case that high-quality sound playing is not permitted (No), the control unit 92 controls the code stream restoration unit 93 to transfer the sample listening frames to the signal component decoding unit 94, and then proceeds to processing in Step S47.

On the other hand, in a case that high-quality sound playing of the distribution data is permitted (Yes) in Step S45, the control unit 92 supplies the additional frames corresponding to the sample listening frames to the code stream restoration unit 93. At the code stream restoration unit 93, the code stream restoration processing described later with reference to the flowchart in FIG. 23 is executed using the additional frames supplied from the control unit 92 in order to restore the coding frames of the original data from the sample listening frames. In the example shown in FIG. 14, the additional frames S1 through S8 are sequentially supplied from the control unit 92 to the code stream restoration unit 93 in sync with the sample listening frames M1 through M8 being supplied from the code stream separation unit 91 to the code restoration unit 93 sequentially.

In Step S47, the signal component decoding unit 94 separates the code stream input into a tone component and a non-tone component, decodes these components by applying inverse quantization and inverse normalization thereto, synthesizes the spectrum signals generated in the decoding, and then outputs this to the inverse conversion unit 95.

In Step S48, the inverse conversion unit 95 separates the spectrum signal input into bands as necessary, applies inverse spectrum conversion to these bands, and then synthesizes the bands so as to inversely convert to a time-series signal.

In Step S49, the control unit 92 determines whether or not there are any coding frames remaining to be played (whether or not there are any coding frames still not played), in a case that there are coding frames yet to be played remained (Yes), the control unit 92 returns to the processing in Step S43, and then executes the subsequent processing repeatedly. On the other hand, in a case that the control unit 92 has determined that there are no more coding frames to be played (No) in Step S49, or in a case that the control unit 92 has determined that the user has instructed to stop the restoration processing, the flow proceeds to Step S50.

In Step S50, the license information control unit 97 updates the number of play times and the accumulated playing time value as necessary, which are the license information of the distribution data, based on the license information acquired in the processing in Step S42, and then the control unit 92 completes the restoration processing.

The time-series signal generated due to inverse conversion by the inverse conversion unit 95 is converted to an analog signal by the A/D conversion unit, and then is output to the speaker of the data playing device 5 so as to be played as audio or output from another device via the network.

Note that while description has been made regarding a case of decoding the sample listening data encoded by being separated into a tone component and a non-tone component, or the original data restored from the sample listening data, even in a case that the sample listening data is not separated into a tone component and a non-tone component, the restoration processing and the playing processing are performed in the same way.

Next, description will be made regarding the code stream restoration processing executed in Step S46 in FIG. 22 with reference to the flowchart in FIG. 23.

In Step S61, the code stream restoration unit 93 receives the sample listening frames input supplied from the code stream separation unit 91. At this time, the control unit 92, synchronously with the sample listening frames received by the code stream restoration unit 93, acquires the additional frames corresponding to the sample listening frames received by the code stream restoration unit 93, and then supplies the additional frames acquired to the code stream restoration unit 93 in Step S62. That is to say, the predetermined sample listening frames and the additional frames corresponding thereto are supplied to the code stream restoration unit 93.

In Step S63, the code stream restoration unit 93 restores the normalization coefficient information substituted with the dummy data of the tone components of the sample listening frames input based on the normalization coefficient information of the tone components written in the additional frames supplied from the control unit 92.

Accordingly, for example, in a case that the sample listening frames in FIG. 11 and the additional data in FIG. 13 are supplied to the code stream restoration unit 93, the normalization coefficient zero substituted with the dummy data of the tone component 42 is restored to the true normalization coefficient 27 written in the additional frame, and also the normalization coefficient zero substituted with the dummy data of the tone component 43 is restored to the true normalization coefficient 24 in the same way by the code stream restoration unit 93.

In Step S64, the code stream restoration unit 93 restores the normalization coefficient information of the non-tone components of the sample listening frames input based on the normalization coefficient information of the non-tone components written in the additional frames supplied from the control unit 92. Therefore, in a case that the sample listening frames in FIG. 11 and the additional data in FIG. 13 are supplied to the code stream restoration unit 93, the normalization coefficient information zero substituted with the dummy data of the band quantization units [13] through [16] is restored to the true normalization coefficients 18, 12, 10, and 8 written in the additional frame respectively.

In Step S65, the code stream restoration unit 93 restores a part of the spectrum coefficient information HC of the non-tone component of the sample listening frames input from the addition frame supplied, based on the true spectrum coefficient information HC of the non-tone component.

Following the processing in Step S65, in a case of high-quality sound play, the flow returns to Step S47 in FIG. 22, there the high-quality sound playing processing is continued, and in a case of high-quality sound recoding, the flow returns Step S87 in FIG. 25 described later, where the high-quality sound recording processing is continued.

According to the above-described processing, the sample listening data included in the distribution data is restored to the original data in high-quality sound, and then the original data restored is played.

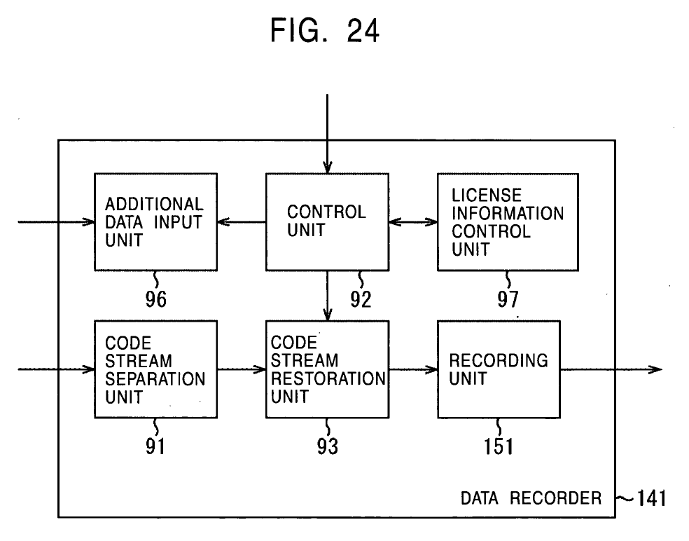

Next, description will be made regarding the configuration of a data recording device for recording the original data restored from the sample listening data and the additional data onto a predetermined recording medium, and the operation thereof. FIG. 24 is a block diagram illustrating a configuration example of a data recording device 141. The components corresponding to the components of the data playing device 5 shown in FIG. 17 will be denoted with the same reference numerals, and description thereof will be omitted.

In a case that a user requests that the sample listening data be recorded in high-quality sound, i.e., the original data be restored from the sample listening data so as to be recorded, the code stream separation unit 91, in response to the sample listening frame input, disassembles the code stream thereof, and then extracts the code of each signal component.

The control unit 92 controls the additional data input unit 96 to receive the additional data supplied, and also supplies the additional data received to the code stream restoration unit 93 as appropriate. Moreover, the control unit 92 controls the code stream restoration unit 93 to modify the sample listening frames to high-quality sound data.

Furthermore, in a case that instructions are made by user operations on the operating input unit to record the distribution data in high-quality sound, i.e., in a case that a request has been made to restore and record the original data, the control unit 92 controls the additional data input unit 96 to acquire the license information of the distribution data. The control unit 92 supplies the license information of the distribution data acquired to the license information control unit 97 to retain the license information of the distribution data in the license information control unit 97.

In the event that the control unit 92 determines that the high-quality sound play of the distribution data is prohibited with reference to the license information of the distribution data, the control unit 92 controls the license information acquisition unit (not shown) to acquire the new license information for permitting recording the distribution data in high-quality sound. Thus, the control unit 92 can update the license information retained by the license information control unit 97. Here, the additional data input unit 96, in a case that the additional data is enciphered, decodes the data, and then supplies the data decoded to the control unit 92 as the additional frame stream, based on the control from the control unit 92.

The code stream restoration unit 93, in a case of high-quality sound recording, restores the sample listening frames supplied from the code stream separation unit 91 to the coding frames of the high-quality sound data using the additional data supplied from the control unit 92, and then outputs the coding frames restored to a recording unit 151.

The recording unit 151 adds the content header including the content ID and the like to the coding frames of the high-quality sound data supplied from the code stream restoration unit 93, adds the license information updated as necessary, and then records this onto a recording medium. The recording unit 151 records the data onto a recording medium such as a magnetic disk, a magneto-optical disc, semiconductor memory, or a magnetic tape, using a predetermined method. Note that the recording unit 151 may record the data within a recording medium (a recording medium detachable as to the data recording device 141), such as memory equipped with a board, a hard disk, or the like.

For example, in a case that the recording unit 151 can record the data onto an optical disk, the recording unit 151 comprises an encoder for converting the data to the data in a format suitable for recording the data onto the optical disk; a laser beam source such as a laser diode; a various lens; an optical unit made up of such as a deviation beam splitter; a spindle motor for rotating and driving the optical disk; a driving unit for driving the optical unit to a predetermined truck position of the optical disk, and a control unit for controlling these.

Note that the recording medium mounted on the recording unit 151 may be the same as the recording medium on which the sample listening data to be input to the code stream separation unit 91, or the additional data to be input to the additional data input unit 96 is recorded. That is to say, in this case, the data recording device 141 reads out the sample listening data recorded onto a certain recording medium, modifies the readout sample listening data to the high-quality sound data, and then records the original data obtained onto the recording medium by such as overwriting.

Next, description will be made regarding the data recording processing executed by the data recording device 141 with reference to the flowchart in FIG. 25.

In Step S81, the additional data input unit 96, in response to the additional data input, identifies the additional frame streams in accordance with control from the control unit 92, and then supplies this to the control unit 92.

In Step S82, the control unit 92 acquires the license information from the additional data input unit 96, and also controls the license information control unit 97 to retain the license information of the distribution data acquired. The control unit 92, in accordance with the request from the user, acquires the new license information for recording the distribution data in high-quality sound.

In the example shown in FIG. 14, the value zero of the number of times for recording Rₘₐₓ of the license information of the distribution data is substituted with the value 1 of the number of times for recording Rₘₐₓ of the license information of the distribution data shown in FIG. 15, and thus, high-quality sound recording is permitted only once. Note that, in an example shown in FIG. 15, while the license conditions other than the number of times for recording Rₘₐₓ are updated, it is needless to say that high-quality sound recording is permitted by updating the number of times for recording Rₘₐₓ alone.

Next, the control unit 92 acquires the content header from the additional data input unit 96, and identifies the sample listening frames to be modified in high-quality sound, of the sample listening frames included in the sample listening data, based on the license information. In the example shown in FIG. 14, the sample listening frames M1 through M8 are identified as the sample listening frames to be modified in high-quality sound.

In Step S83, the control unit 92 determines whether or not high-quality sound recording is permitted, and in a case that high-quality sound recording is not permitted (No), the recording processing for the high-quality sound data ends, while on the other hand, in a case that high-quality sound recording is permitted (Yes), the flow proceeds to the next Step S84.

In Step S84, the code stream separation unit 91, in response to the sample listening frame input included in the sample listening data, proceeds to the processing in Step S85, disassembles the code stream input, and then outputs this to the code stream restoration unit 93. In the example shown in FIG. 14, the sample listening frames M1 through M8 are sequentially input to the code stream restoration unit 93.

In Step S86, the control unit 92 supplies the additional frames corresponding to the sample listening frames to the code stream restoration unit 93. The code stream restoration unit 93 executes the code stream restoration processing described above with reference to the flowchart in FIG. 23 using the additional frames supplied from the control unit 92 in order to restore the coding frames of the original data from the sample listening frames. In the example shown in FIG. 14, the additional frames S1 through S8 are sequentially supplied from the control unit 92 to the code stream restoration unit 93 in sync with the sample listening frames M1 through M8 being sequentially supplied from the code stream separation unit 91 to the code stream restoration unit 93.

Following the code stream restoration processing in Step S86, the recording unit 151 adds the header information to the code streams supplied from the code stream restoration unit 93, and then records the data obtained onto the recording medium mounted thereupon. In the example shown in FIG. 14, the coding frames C1 through C8 of the high-quality sound data are sequentially recorded.

In Step S88, the control unit 92 determines whether or not there are any coding frames still not recorded, of the sample listening frames to be recorded in high-quality sound which has been identified in the processing in Step S82, and in a case that there are the frames to be recorded (Yes), the flow returns to Step S84, where the subsequent processing is performed repeatedly.

On the other hand, in a case that the control unit 92 has determined that there are no more frames to be recorded (No) in Step S88, i.e., of the sample listening data, the low-quality sound portion has all been modified into high-quality sound and then recorded, the flow proceeds to the processing in Step S89.

In Step S89, the license information control unit 97 updates the license information acquired in the processing in Step S82 as necessary. For example, as shown in the lower portion in FIG. 15, the license information control unit 97 substitutes the license information of the distribution data with the license information for high-quality sound data. The recording unit 151 records the content header and the license information updated onto a recording medium, and then the recording processing for high-quality sound data ends.

According to the above-described processing, the original data in high-quality sound is recorded onto a predetermined recording medium. The user may listen to the original data, for example, by mounting the recording medium on a portable audio player, or the like.

As described above, in a case that the original data is separated into the sample listening data a part of which is substituted with the dummy data and the additional data including the true values of the dummy data, and then these data is integrated along with the license information so as to be distributed, the high-quality sound play and the high-quality sound recording of the content using the sample listening data and the additional data is restricted under various conditions, whereby a contents distribution service can be realized such that high-quality sound playing is permitted within a time limit while the high-quality sound recording of the content is prohibited, for example.

A contents provider, in a case of distributing a content, generates the sample listening data of which a part of the original data is substituted with the dummy data and the additional data with small capacity including the true values of the dummy data, adds the license information thereto, and then distributes this, whereby effective vending and sales promotion can be performed while protecting copyrights.

Alternately, a content user can select either purchasing the license information for playing the distribution data in high-quality sound or purchasing the license information for recording the distribution data in high-quality sound, so the user can purchase the most appropriate content according to how he/she plans to use the content.

The additional data made up of the additional frames on which the true values corresponding to the dummy data substituted at the time of generating the sample listening data (for example, the true normalization coefficient information or the true spectrum coefficient information or the like) are written is generated, whereby the original data can be restored from the sample listening data using the additional data.

While the above description has been made regarding the playing and recording processing wherein the sample listening data of the content data made up of audio signals and the additional data corresponding thereto are generated, the original data is restored from the sample listening data and the additional data, and then is played or recorded, the present invention may be applied to the distribution of content data made up of image signals only or image signals and audio signals.

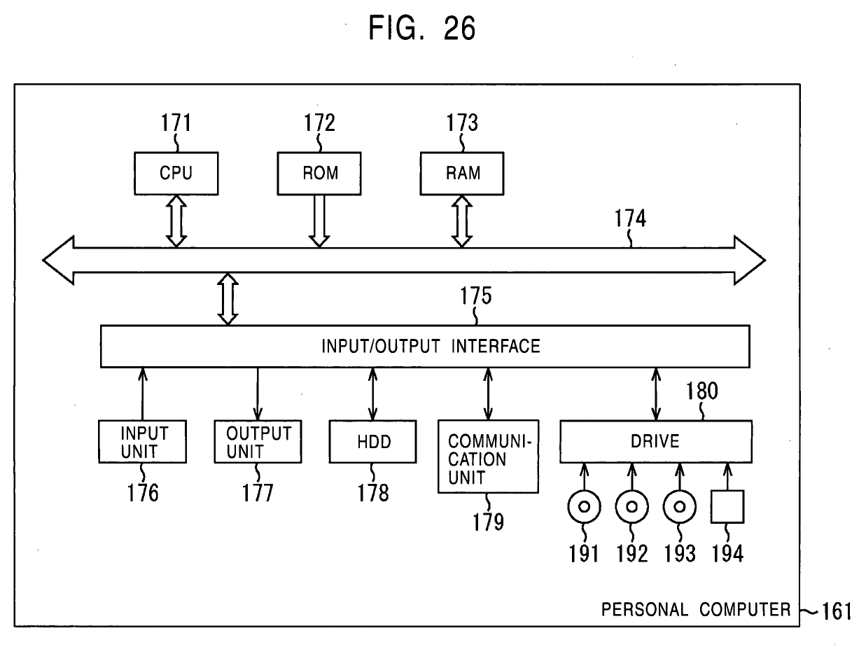

The above-described series of processing may be executed by either hardware or software. In the case of software, the coding device 1, the data playing device 5, or the data recording device 141, is configured of a personal computer 161 as shown in FIG. 26, for example.

In FIG. 26, a CPU (Central Processing Unit) 171 executes various processing in accordance with the program stored in ROM (Read Only Memory) 172, or the program loaded from an HDD (Hard Disk Drive) 178 to RAM (Random Access Memory) 173. The RAM 173 also stores data required for various processing executed by the CPU 171 as appropriate. The CPU 171, the ROM 172, and the RAM 173 are mutually connected via a bus 174. This bus 174 is also connected with an input/output interface 175.

The input/output interface 175 is connected with an input unit 176 made up of a keyboard, a mouse, and the like, an output unit 177 made up of a display, or the like, the HDD 178 made up of a hard disk, or the like, and a communication unit 179. The communication unit 179 performs communication processing via a network including the computer network 4 in FIG. 1.

The input/output interface 175 is also connected with a drive 180 as necessary on which a magnetic disk 191, an optical disk 192, a magneto-optical disk 193, or semiconductor memory 194 are mounted as appropriate, and a computer program read out therefrom is installed in the HDD 178 as necessary.

In the event that a series of processing is executed by software, programs making up the software are installed in a computer with built-in dedicated hardware, or a general-purpose personal computer capable of executing various functions by installing various programs through a network or a recording medium.

This recording medium comprises not only packaged media made up of the magnetic disk 191 (including floppy disks), the optical disk 192 (including CD-ROMs (Compact Disk-Read Only Memory) and DVDs (Digital Versatile Disk), the magneto-optical disk 193 (including MDs (Mini-Disk)), semiconductor memory 194, or the like, on which a program is stored to be distributed to a user separately from the device main unit, but also the ROM 172 and the HDD 178 in which a program is stored to be provided to a user in a built-in state, as shown in FIG. 26.

Note that with the present specification, steps for writing a program to be stored in a recording medium include not only processing performed in time sequence following the order included therein, but also processing performed in parallel or individually. Also, with the present specification, the term “system” represents the entire device made up of multiple devices.

1. A data generating method comprising:
a first generating step for substituting first data included in a first data stream with second data so as to generate a second data stream;
a second generating step for generating a third data stream including said first data for restoring said first data stream from said second data stream generated by the processing of said first generating step; and
a third generating step for generating control data for stipulating at least one of
a condition for restoring said first data stream from said second data stream using said third data stream; and
a condition for usage of said first data stream restored from said second data stream.

2. A data generating method according to claim 1, wherein said control data stipulates at least one of the following:
the limit of time;
the period of time; and
the number of times;
as a condition for permitting restoring of said first data stream from said second data stream.

3. A data generating method according to claim 1, wherein said control data stipulates conditions for recording said data stream onto other recording media.

4. A data generating method according to claim 1, wherein, with the processing of said first generating step, said first data is substituted with said second data such that output quality obtained by restoring said second data stream is inferior to output quality obtained by restoring said first data stream.

5. A data generating method according to claim 1, further including a coding step for encoding data input, wherein, with the processing of said first generating step, in a case of using coded data encoded by said coding step as said first data stream, said second data stream is generated by substituting said first data stream with said second data stream.

6. A data generating method according to claim 5, wherein said first data includes at least one of normalization coefficient information and quantization precision information of coding by the processing of said coding step.

7. A data generating method according to claim 1, further comprising:
a frequency component conversion step for converting input data to a frequency component; and
a coding step for encoding said data converted to a frequency component by the processing of said frequency component conversion step;
wherein, with the processing of said first generating step, in a case of using coded data encoded by said coding step as said first data stream, said first data is substituted with said second data so as to generate said second data stream;
and wherein said first data includes spectrum coefficient information of the frequency component converted by the processing of said frequency component conversion step.

8. A data generating method according to claim 1, wherein said first data includes data subjected to variable length coding.

9. A data generating method according to claim 1, wherein conditions stipulated by said control data are updatable conditions.

10. A data generating device comprising:
first generating means for generating a second data stream by substituting first data included in a first data stream with second data;
second generating means for generating a third data stream including said first data for restoring said first data stream from said second data stream generated by said first generating means; and
third generating means for stipulating at least one of
a condition for restoring said first data stream from said second data stream using said third data stream, and
a condition for usage of said first data stream restored from said second data stream.

11. A computer-readable program comprises:
code for a first generating step for generating a second data stream by substituting first data included in a first data stream with second data;
code for a second generating step for generating a third data stream including said first data for restoring said first stream from said second data stream generated by the processing of said first generating step; and
code for a third generating step for stipulating at least one of
a condition for restoring said first data stream from said second data stream using said third data stream, and
a condition for usage of said first data stream restored from said second data stream.

12. A data restoring method for restoring a first data stream from a predetermined data stream, said data restoring method comprising:
a restoring step for restoring said first data stream from a second data stream generated by substituting first data included in said first data stream with second data using a third data stream including said first data; and
a determining step for determining whether or not said first data stream can be restored by said restoring step based on a condition for restoring said first data stream from said second data stream, which is stipulated by control data;
wherein the restoration of said first data stream by the processing of said restoring step is performed in the event that determination is made that said first data stream can be restored by the processing of said determining step.

13. A data restoring method according to claim 12, wherein said control data further stipulates a condition for usage of said first data stream restored from said second data stream.

14. A data restoring method according to claim 13, further comprising a recording control step for recording said first data stream restored by the processing of said restoring step onto a predetermined recording medium, wherein recording of said first data stream is performed using the processing of said recording control step in the event that recording of said first data stream is permitted under a condition for usage of said first data stream, which is stipulated by said control data.

15. A data restoring device for restoring a first data stream from a predetermined data stream, said data restoring device comprising:
restoring means for restoring said first data stream from a second data stream generated by substituting first data included in said first data stream with second data using a third data stream including said first data; and
determining means for determining whether or not said first data stream can be restored by said restoring means based on a condition for restoring said first data stream from said second data stream, which is stipulated by control data;
wherein said restoring means perform the restoration of said first data stream in the event that said determining means determine that restoration of said first data stream can be performed.

16. A program for causing a computer to execute processing for restoring a first data stream from a predetermined data stream, said program comprising:
code for a restoring step for restoring said first data stream from a second data stream generated by substituting first data included in said first data stream with second data using a third data stream including said first data; and
code for a determining step for determining whether or not said first data stream can be restored by said restoring step based on a condition for restoring said first data stream from said second data stream, which is stipulated by control data;
wherein the restoration of said first data stream by the processing of said restoring step is performed in the event that determination is made that said first data stream can be restored by the processing of said determining step.
